(19) United States
(12) Patent Application Publication
(10) Pub. No.: US 2004/0102649 A1
(43) Pub. Date: May 27, 2004

(54) Water soluble chiral diphoshpines

(76) Inventors: Christine Saluzzo, Lyon (FR); Thierry Lamouille, Lyon (FR); Marc Lemaire, Villeurbanne (FR); Robert Ter Halle, Collonges Au Mont D'Or (FR)

Correspondence Address: BURNS DOANE SWECKER & MATHIS L L P, POST OFFICE BOX 1404, ALEXANDRIA, VA, 22313-1404, US

(21) Appl. No.: 10/240,572

(22) PCT Filed: Apr. 3, 2001
(86) PCT No.: PCT/FR01/01000

(30) Foreign Application Priority Data
Apr. 3, 2000 (FR) 00/04232

(51) Int. Cl. C07F 9/28

(52) U.S. Cl. 564/15

(57) ABSTRACT

The invention concerns a water soluble compound of formula (a) wherein: A represents naphthyl or phenyl; and Ar₁ and Ar₂ independently represent a saturated or aromatic carbocyclic group; Xₐ, X_{b} are independently selected among an amino group, an ammonium group and an amino group modified by a linear polyoxyalkylene chain, provided that at least one of Xₐ and X_{b} represents ammonium or modified amino.

The invention relates to water-soluble chiral diphosphines that are useful as ligands in the synthesis of water-soluble complexes for asymmetric catalysis.

The preparation of water-soluble catalyst complexes is desirable in order to facilitate the implementation of asymmetric reactions in two-phase medium. Moreover, providing water-soluble catalyst complexes makes it possible to carry out asymmetric reactions in aqueous or single-phase aqueous-organic medium.

In the case of asymmetric reactions carried out in two-phase medium, the catalyst is readily separated from the reaction products by removal of the aqueous phase, the reaction products remaining solubilized in the organic phase.

In the case of asymmetric reactions carried out in a one-phase medium, the catalyst may be separated from the reaction medium by nanofiltration by passing the reaction medium through suitable membranes.

Patent application FR 99 02 119 relates to a process for preparing chiral diphosphines that are useful as ligands in the synthesis of complexes for asymmetric catalysis, which correspond to formula I:

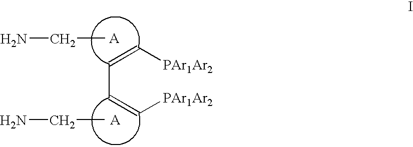

in which A represents naphthyl or phenyl; and

Ar₁ and Ar₂ independently represent an aromatic or saturated carbocyclic group.

These compounds are not water-soluble and lead to the preparation of complexes that are not water-soluble.

The present invention provides water-soluble ligands prepared from the compounds of formula I which may be used in the preparation of water-soluble complexes that are efficient in asymmetric catalysis.

More specifically, and according to a first of its aspects, the invention relates to a water-soluble compound of formula α

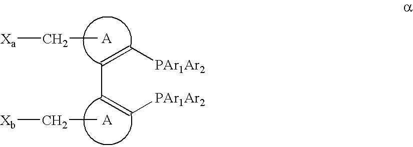

in which:

A represents naphthyl or phenyl; and

Ar₁ and Ar₂ independently represent an aromatic or saturated carbocyclic group;

Xₐ and X_{b} are independently chosen from an amino group, an ammonium group and an amino group modified with a linear polyoxyalkylene chain;

it being understood that at least one from among Xₐ and X_{b} represents ammonium or modified amino.

In the context of the invention, the phenyl and naphthyl radicals are optionally substituted.

According to the invention, the term “carbocyclic radical” means an optionally substituted, preferably C₃-C₅₀ monocyclic or polycyclic radical. Preferably it is a C₃-C₁₈ radical, which is preferably mono-, bi- or tricyclic.

The carbocyclic radical may comprise a saturated portion and/or an aromatic portion.

When the carbocyclic radical comprises more than one cyclic nucleus (in the case of polycyclic carbocycles), the cyclic nuclei may be fused in pairs or attached in pairs via σ bonds.

Examples of saturated carbocyclic radicals are cycloalkyl groups.

Preferably, the cycloalkyl groups are saturated cyclic hydrocarbon-based radicals that are preferably C₃-C₁₈ and better still C₃-C₁₀, and in particular cyclopentyl, cyclohexyl, cycloheptyl, cyclooctyl, adamantyl or norbornyl radicals.

Examples of aromatic carbocyclic radicals are (C₆-C₁₈)aryl groups and in particular phenyl, naphthyl, anthryl and phenanthryl.

The substituents on the phenyl, naphthyl and carbocyclic radicals may be of any nature provided that they do not interfere with the complexation of the ligand to the metal during the preparation of the catalyst.

Examples of substituents are alkyl, alkoxy, thioalkoxy, alkoxyalkyl, thioalkoxyalkyl and polyoxyalkylene radicals, —SO₃H, —SO₃M in which M is an ammonium or metal cation, —PO₃H₂, —PO₃HM or —PO₃M₂ in which M is as defined above.

In the context of the invention, the term “alkyl” means a linear or branched hydrocarbon-based radical preferably containing from 1 to 15 carbon atoms and better still from 1 to 10 carbon atoms, for example from 1 to 6 carbon atoms.

Preferably, M is a cation of an alkali metal such as Na, Li or K.

It is desirable for the substituents not to interfere with the reactions carried out in the preparation of the compounds a from the suitable compounds of formula I. However, protection and deprotection steps may be envisaged, where necessary. A person skilled in the art may refer to the following two publications in order to perform the protection of specific organic functions:

Protective Groups in Organic Synthesis, Green T. W. and Wuts P. G. M. ed. John Wiley and Sons, 1991; and

Protecting Groups, Kocienski P. J., 1994, Georg Thieme Verlag.

In the alkyl, alkoxy, thioalkoxy, alkoxyalkyl and thioalkoxyalkyl radicals, the alkyl portions are linear or branched saturated hydrocarbon-based radicals especially containing up to 25 carbon atoms, for example from 1 to 12 carbon atoms and better still from 1 to 6 carbon atoms.

Examples of alkyl groups are methyl, ethyl, propyl, isopropyl, butyl, isobutyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl, 1-methyl-1-ethylpropyl, heptyl, 1-methylhexyl, 1-propylbutyl, 4,4-dimethylpentyl, octyl, 1-methylheptyl, 2-ethylhexyl, 5,5-dimethylhexyl, nonyl, decyl, 1-methylnonyl, 3,7-dimethyloctyl and 7,7-dimethyloctyl radicals.

The expression “substituent of polyoxyalkylene type” means a linear polyoxyalkylene chain attached to the phenyl, naphthyl and carbocyclic groups via an oxygen atom located at the end, said chain consisting of oxyalkylene units in which alkylene is preferably C₂-C₅ and better still C₂-C₃.

In general, said chain comprises up to 200 and preferably from 100 to 150 oxyalkylene units.

Preferably, the substituents are alkyl or alkoxy groups.

In a particularly advantageous manner:

A represents naphthyl or phenyl, optionally substituted with one or more radicals chosen from (C₁-C₆)alkyl and (C₁-C₆) alkoxy; and

Ar₁ and Ar₂ independently represent a phenyl group optionally substituted with one or more (C₁-C₆)alkyl or (C₁-C₆)alkoxy; or a (C₄-C₈)cycloalkyl group optionally substituted with one or more (C₁-C₆)alkyl groups.

Examples of preferred alkyl groups are, in particular, methyl, ethyl, propyl, isopropyl, butyl, isobutyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl and 1-methyl-1-ethylpropyl.

Advantageously, the alkyl radical contains from 1 to 4 carbon atoms.

The term “alkoxy” denotes an —O-alkyl radical in which alkyl is as defined above.

Advantageously, the cycloalkyl groups are chosen from cyclobutyl, cyclopentyl, cyclohexyl, cycloheptyl and cyclooctyl.

It should be understood that, according to the invention, each of the naphthyl and phenyl groups representing A may be substituted.

Among the compounds of formula a that are preferred are those for which Ar₁ and Ar₂ are, independently, phenyl optionally substituted with methyl or tert-butyl; or (C₅-C₆)cycloalkyl optionally substituted with methyl or tert-butyl.

The compounds that are most particularly preferred are those of formula a in which Ar₁ and Ar₂ are identical. A clearly preferred meaning of Ar₁ and Ar₂ is optionally substituted phenyl.

Moreover, it is preferred for A to represent naphthyl optionally substituted with one to five and preferably one to two groups chosen from (C₁-C₆)alkyl and (C₁-C₆)alkoxy. Better still, A represents unsubstituted naphthyl.

When A represents optionally substituted phenyl, it is preferred for this phenyl to be substituted in the meta position relative to the group PAr₁Ar₂ with (C₁-C₆)alkyl or (C₁-C₆)alkoxy and better still with methyl or methoxy, the other positions of the phenyl radical being unsubstituted.

One group of compounds that is more particularly preferred consists of the compounds of formula a prepared from compounds of formula I with a C₂ axis of symmetry, with the exclusion of any other element of symmetry.

The notion of the C₂ axis of symmetry is described in “Elements of Stereochemistry”, Wiley, New York, 1969 and in “Advanced Organic Chemistry”, Jerry March, Stereochemistry, Chapter 4.

Among these compounds of formula I especially distinguished are the compounds of formulae Ia and Ib below:

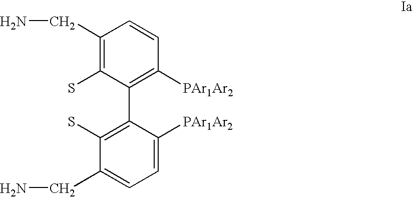

in which Ar₁ and Ar₂ are as defined above and S represents a compatible substituent as defined above, and for example alkyl or alkoxy, which is preferably C₁-C₆,

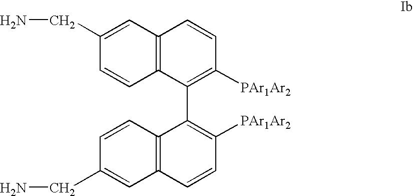

in which Ar₁ and Ar₂ are as defined above.

In general, the compounds of formula I are optically active.

The racemic mixtures of the compounds of formula I lead to racemic compounds a that may be used according to the invention in combination with a chiral amine for the selective hydrogenation of ketones, as will be explained hereinbelow.

The expression “amino group modified with a polyoxyalkylene chain” denotes an amino group linked to a polyoxyalkylene chain via a suitable bridging chain.

In general, a polyoxyalkylene chain is a polymer chain consisting of alkylene oxide units, preferably of C₂-C₅, for example of C₂-C₃.

Advantageously, the repeating units of the polyoxyalkylene chains have the formula:

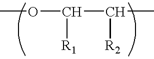

in which

R₁ and R₂ are independently chosen from a hydrogen atom; an alkyl group optionally substituted with aryl; alkoxy and/or aryloxy; an aryl group; each aryl group optionally being substituted.

The alkyl and aryl groups are generally as defined above.

Suitable substituents of the aryl group are, for example, alkyl and alkoxy.

In a particularly advantageous manner, R₁ and R₂ in the above formula represent a hydrogen atom.

The following are preferably distinguished:

the compounds of the formula α of the “ammonium salt” type in which at least one from among Xₐ and X_{b} represents an ammonium group;

the compounds of formula a of the “polyoxyalkylene derivative (i)” type in which at least one from among Xₐ and X_{b} represents an amino group modified with a polyoxyalkylene chain.

A first group of ammonium salts consists of salts resulting from the addition of a compound of formula I

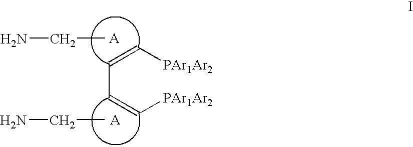

in which A, Ar₁ and Ar₂ are as defined above, with a mineral acid.

A second group of ammonium salts consists of salts resulting from the addition of a compound of formula I

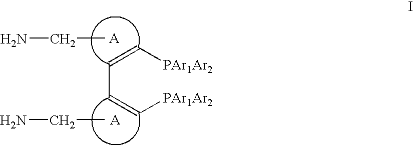

in which A, Ar₁ and Ar₂ are as defined above, with an organic acid.

As mineral acids that are suitable for preparing a salt of a compound of formula I, mention may be made of nitric acid, a hydrohalic acid (such as hydrochloric acid or hydrobromic acid), a sulfuric acid (at least one acid function of which is in free form, the other optionally being in salified form) or a phosphoric acid (at least one acid function of which is in free form, the others optionally being in salified form).

When the sulfuric or phosphoric acid has at least one acid function in salified form, this function is preferably salified with an alkali metal or alkaline-earth metal.

When the mineral acid is a diacid XH₂, the formula of the salt of the compound of formula I is preferably as follows:

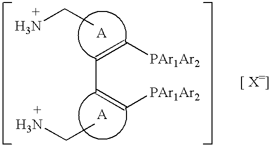

symbolized by [IH₂²⁺]X^{═} in which I represents the compound of formula (I) and H represents a hydrogen atom.

When the mineral acid is a monoacid XH, the formula of the salt is [IH₂²⁺][X⁻]₂.

As preferred addition salts with a mineral acid, mention will be made of dibromate, phosphate, sulfate and dinitrate.

As preferred organic acid for the preparation of a salt of a compound of formula I, mention may be made of monocarboxylic and dicarboxylic acids, and more generally polycarboxylic and sulfonic acids.

The term “monocarboxylic acid” denotes a saturated aliphatic and/or saturated cyclic or aromatic molecule bearing a single —COOH function.

The expression “aliphatic and cyclic molecule” means a molecule comprising both a cyclic portion and an aliphatic portion.

According to the invention, the term “polycarboxylic” means saturated aliphatic and/or saturated cyclic or aromatic molecules bearing more than one —COOH function, preferably bearing 1, 2 or 3 —COOH functions.

The cyclic carboxylic acids are monocyclic or polycyclic carbocyclic or heterocyclic.

The saturated or aromatic carbocyclic radicals are as defined above.

Examples of saturated or aromatic mono- or polycyclic heterocycles forming the heterocyclic radicals are pyridine, furan, thiophene, pyrrole, pyrrazole, imidazole, thiazole, isoxazole, isothiazole, pyridazine, pyrimidine, pyrazine, triazines, indolizine, indole, isoindole, benzofuran, benzothiophene, indazole, benzimidazole, benzothiazole, purine, quinoline, isoquinoline, cinnoline, phthalazine, quinazoline, quinoxaline, pterine, naphthyridines, carbazole, acridine, phenazine, oxazole, pyrazole, oxadiazole, triazole and thiadiazole and, where appropriate, the saturated derivatives thereof. Other examples are pyrrolidine, dioxolane, imidazolidine, pyrazolidine, piperidine, dioxane, morpholine, dithiane, thiomorpholine, piperazine and trithiane.

Heterocycles that are particularly preferred are especially pyridine, furan, thiophene, pyrrole, benzofuran and benzothiophene.

Examples of carboxylic acids are acetic acid, propionic acid, glycolic acid, pyruvic acid, oxalic acid, malic acid, malonic acid, succinic acid, maleic acid, fumaric acid, tartaric acid, citric acid, cinnamic acid, manoleic acid, triflic acid, methanesulfonic acid, ethanesulfonic acid, p-toluenesulfonic acid, salicylic acid and benzoic acid.

The addition salt is readily prepared by placing the acid in contact with the compound of formula I, at room temperature, in a suitable solvent capable of dissolving the compound of formula I. A suitable solvent is, for example, an aprotic solvent such as a halogenated aliphatic hydrocarbon (of the type such as dichloromethane or trichloroethylene) or a halogenated aromatic hydrocarbon such as halobenzene or halotoluene.

When the acid is monocarboxylic, it is necessary to react at least two equivalents of acid with the compound of formula I.

When the acid is dicarboxylic, one molar equivalent is sufficient. However, the use of an excess of acid is possible.

In the case of polycarboxylic acid, a person skilled in the art will readily determine the amount of acid required for the salification.

The formation of an amine salt forms part of the knowledge of a person skilled in the art.

Surprisingly, the inventors realized that after coordination with a suitable metal, the resulting water-soluble complex acts as a catalyst in asymmetric synthesis.

The preparation of the complexes under consideration is described later.

As a variant, it will be noted that the complexation and salification may be performed in a single step, as will be described later.

In general, the preferred polyoxyalkylene derivatives (i) of the invention consist of one or more polyoxyalkylene chains, of one or more groups G₁ of formula:

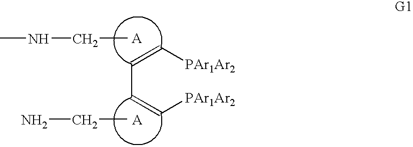

and/or of one or more groups G₂ of formula:

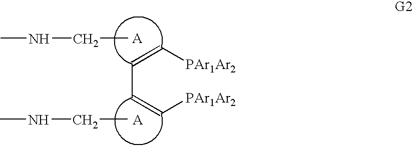

in which A, Ar₁ and Ar₂ are as defined above, and also comprise the number of bridging chains that is suitable for attaching said groups G₁ and G₂ to said polyoxyalkylene chains.

The groups G₁ and/or G₂ can either cap the ends of polyoxyalkylene chains, or can be linked to internal units of said polyoxyalkylene chains.

A first type of polyoxyalkylene derivative (i) is a linear polyoxyalkylene bearing at least one group G₁ as defined above. In this type of derivative, G₁ may be located at the end of the polyoxyalkylene chain, or may be attached to an internal unit of the polyoxyalkylene chain so as not to cap either of the ends of the polyoxyalkylene chain.

A second type of polyoxyalkylene derivative (i) consists of at least one group G₂ as defined above, each amino radical of said group G₂ being attached to a polyoxyalkylene chain.

In this type of derivative, the two amino radicals of the same group G₂ may be attached to the same polyoxyalkylene chain or to two different polyoxyalkylene chains. Moreover, each NH radical of said groups G₂ can either cap the end of a polyoxyalkylene chain, or can be connected to an internal unit of a polyoxyalkylene chain so as not to cap the end of a polyoxyalkylene chain.

According to one preferred embodiment of the invention, the NH radicals of the groups G₁ and/or G₂ above which are linked to the end of a polyoxyalkylene chain are attached to said polyoxyalkylene chain via a bridging chain of formula:

—C-alk-D

in which C is linked to —NH— and D is linked to the oxygen atom of the end of the polyoxyalkylene chain, and in which

C represents a bond, the group —CO—; or —CO—NH—;

alk represents a bond, an alkylene group or a group —CH(L)- in which L is the side chain of an α-amino acid to which a polyoxyalkylene chain is optionally grafted; and

D represents a —CO— group; —NH—CO—; or a —CH(OH)—CH₂— group.

Advantageously, said bridging chain —C-alk-D- is chosen from:

-alk-NH—CO—

—CO-alk-CO—

-alk-CO—

-alk-CO-alk-CH(OH)—CH₂— and

—CO—

in which alk represents alkylene, or alternatively the residue —C-alk-D- represents —CO—NH—CH(L)-CO— in which L is the side chain of a natural or synthetic α-amino acid onto which is optionally grafted a polyoxyalkylene chain.

An example of a side chain bearing a polyoxyalkylene chain is a side chain comprising an amino group linked to a polyoxyalkylene chain via a suitable bridging chain.

In general, the term “alkylene” denotes a linear or branched divalent aliphatic hydrocarbon-based group preferably containing from 1 to 10 carbon atoms, better still from 1 to 6 carbon atoms and more advantageously from 1 to 2 carbon atoms.

According to the invention, the term “α-amino acid” means any natural α-amino acid or any analog or synthetic derivative that may be envisaged. The letter a indicates that the amino function and the carboxylic acid function of the α-amino acid are attached to the same carbon atom, which also bears a hydrogen atom and a side chain L.

The side chains of the natural α-amino acids are well known. The side chain may represent a hydrogen atom (as in the case of glycine); an alkyl group (as in the case of alanine, valine, leucine, isoleucine and proline); an alkyl group substituted with hydroxyl, with alkylthio, with thiol, with carboxyl, with amino, with aminocarbonyl and/or with guanidino (as in the case of threonine, serine, methionine, cysteine, aspartic acid, asparagine, glutamic acid, glutamine, arginine and lysine); an arylalkyl group optionally substituted, for example, with hydroxyl (as in the case of tyrosine and phenylalanine); or a heteroarylalkyl group (as in the case of tryptophan and histidine).

The side chains of synthetic α-amino acids are described in the literature, for example in Williams (ed), Synthesis of Optically Active α-Amino Acids, Pergamon Press (1989); Evans et al., J. Amer. Chem. Soc. 112, 4011-4030 (1990); Pu et al. J. Amer. Chem. Soc. 56, 1280-1283 (1991); and Williams et al. J. Amer. Chem. Soc. 113, 9276-9286 (1991).

When the side chain of the amino acid bears an amino function, this function may optionally be substituted with a polyoxyalkylene chain.

Particularly preferred meanings of —C-alk-D- are:

—CH₂—CH₂—NH—CO—;

—CO—CH₂—CH₂—CO—;

—CH₂—CH₂—CO—;

—CO—;

—CH₂—CO—;

—CH₂—CH(OH)—CH₂;

—CO—NH—CH(L)-CO— in which L represents the side chain of an α-amino acid, or alternatively the side chain of a basic α-amino acid containing a terminal amino group substituted with —CO—O—POA, POA representing a polyoxyalkylene chain.

Side chains that are particularly advantageous are the side chains H (glycine), —(CH₂)₃—OH (norleucine) and —(CH₂)₄—NH—CO—O—POA in which POA is a polyoxyalkylene chain.

As a variant, the groups G₁ and/or G₂ are attached to the polyoxyalkylene chain without capping the ends of said chain. In the context of the invention, to characterize this type of attachment, it is pointed out that the groups G₁ and/or G₂ are linked to an internal unit of the polyoxyalkylene chain. In this case, it is preferred for the —NH— radicals of the groups G₁ and G₂ to be linked to said polyoxyalkylene chain via a bridging chain of formula -alk-CO— in which alk represents an alkylene chain as defined above, CO is linked to NH and alk is directly attached to the polyoxyalkylene chain. Better still, the side chain has the formula —CH₂—CH₂—CO—.

The polyoxyalkylene derivative (i) comprises less than 20 groups G₁ and/or G₂, preferably less than 15 and better still less than 10.

A first preferred subgroup of polyoxyalkylene derivatives (i) consists of polyoxyalkylene derivatives comprising a single group G₁ or a single group G₂. For these derivatives (i), it is preferred for the groups G₁ or G₂ to be attached to the end of a polyoxyalkylene chain.

Another preferred subgroup of polyoxyalkylene derivatives consists of polyoxyalkylene derivatives (i) comprising from 2 to 20 groups G₁ and/or G₂, preferably from 3 to 15 and better still from 4 to 10. For these derivatives (i), it is preferred for the groups G₁ or G₂ not to cap the ends of the polyoxyalkylene chains, but rather to be attached to internal units of said polyoxyalkylene chains. Better still, this latter type of derivative (i) exclusively comprises groups G₁.

The ends of the polyoxyalkylene chains not bearing a group G₁ or G₂ are preferably capped with hydroxyl or alkoxy groups.

As an indication, when the derivative (i) comprises a single group G₁, this group is preferably linked to a linear polyoxyalkylene chain containing at least 20, preferably between 20 and 150 and better still between 50 and 120 “alkylene oxide” units. For a value of the number of alkylene oxide units of between 20 and 150, the molar mass of the derivative (i) preferably ranges between 1 000 and 9 000. For a value of the number of alkylene oxide units of between 50 nd 120, the molar mass of the derivative (i) preferably ranges between 3 000 and 7 000.

When the derivative (i) comprises a single group G₂, this group is preferably linked to two linear polyoxyalkylene chains via each of its —NH groups, each linear polyoxyalkylene chain containing at least 10, preferably between 10 and 150 and better still between 50 and 120 “alkylene oxide” units. In this case, when the number of alkylene oxide units ranges between 10 and 150, the molar mass preferably ranges between 2 000 and 15 000. For a value of the number of alkylene oxide units of between 50 and 120, the molar mass preferably ranges between 5 000 and 12 000.

More generally, it will be easy for a person skilled in the art to vary the size of the polyoxyalkylene chains in the derivative (i) as a function of the number of groups G₁ and/or G₂ so as to ensure the water-solubility of the resulting compound.

A subgroup of the compounds of the invention that is also preferred consists of the water-soluble compounds of formula II below:

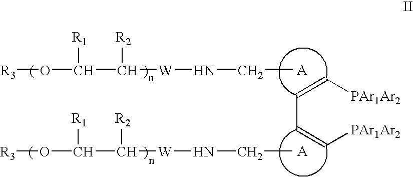

in which

A, Ar₁ and Ar₂ are as defined above,

R₁ and R₂ are as defined above,

n, which is an average value, ranges between 5 and 150, preferably between 15 and 150 and better still between 50 and 120;

R₃ represents H or alkyl;

W represents —O—C-alk-D, in which C, alk and D are as defined above.

More generally, n is defined so as to ensure the water-solubility of the corresponding compound II.

In the context of the invention, the term “water-soluble” means a molecule that is more soluble in water than in 1-octanol, as described in “Principles and Practices of solvent extraction”, J. Rydberg, C. Musikas and G. R. Choppin, 1992, published by M. Dekker, chapter II, page 66.

More particularly, n is at least 10. Preferably, n is between 10 and 150 and better still between 50 and 120. Preferably, the molar mass of compound II ranges between 2 000 and 15 000 and better still between 5 000 and 12 000.

When alk represents —CH(L)- in which L bears a group POA, it is desirable for POA to represent the monovalent group of formula:

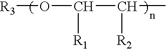

in which R₁, R₂, n and R₃ are as defined above.

The preferred compounds II are those for which R₁═R₂═H. Among these compounds, the ones that are preferred are those for which R₃═H or —OCH₃.

Even more preferably, it is preferred for the compound α to be a compound of formula:

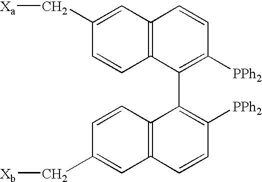

The compounds a are simply prepared from the corresponding compounds of formula I.

The compounds of formula I may be prepared by carrying out the following process, which comprises the steps consisting in:

i) brominating a diol of formula XXXIV:

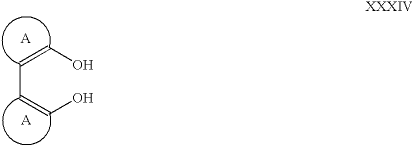

in which A is as defined above, using a suitable brominating agent so as to obtain a dibromo compound of formula XXXV:

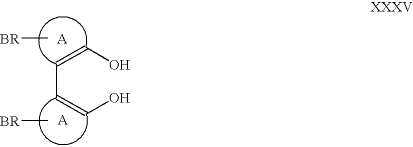

in which A is as defined above;

ii) esterifying the compound of formula XXXV obtained in the preceding step by the action of a sulfonic acid or an activated form thereof, so as to obtain the corresponding disulfonate;

iii) substituting the two bromine atoms with cyano groups by reacting the disulfonate obtained in the preceding step with a suitable nucleophilic agent so as to obtain the corresponding nitrile;

iv) coupling a phosphine of formula XXXVI:

XPAr₁Ar₂ XXXVI

in which X represents a hydrogen atom or a halogen atom and Ar₁ and Ar₂ are as defined above, with the nitrile obtained in the preceding step, in the presence of a catalyst based on a transition metal, so as to obtain the corresponding compound of formula XXXIX:

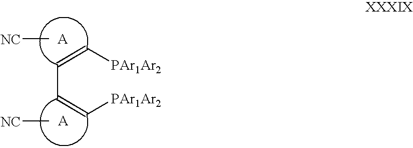

in which A, Ar₁ and Ar₂ are as defined above; and

v) reducing the nitrile function of the compound thus obtained by the action of a reducing agent, so as to obtain the expected compound of formula I.

In step (i) the phenyl or naphthyl nucleus, respectively, of the diol of formula II is brominated by the action of a suitable brominating agent.

When A is an unsubstituted phenyl nucleus or a nucleus bearing a substituent in the meta position relative to the OH group, such as (C₁-C₆)alkyl or (C₁-C₆)alkoxy, the corresponding diol of formula XXXIVa:

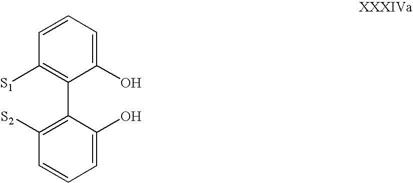

which S₁ and S₂ are as defined for S above or independently represent a hydrogen atom or an alkyl or alkoxy group, which is preferably C₁-C₆, gives the corresponding bromo compound of formula XXXVa:

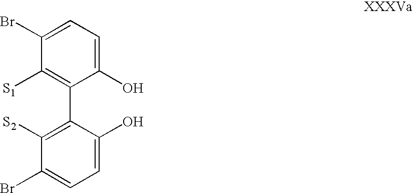

in which S₁ and S₂ are as defined above.

When A is a naphthyl nucleus, the bromination of the corresponding diol of formula XXXIVb:

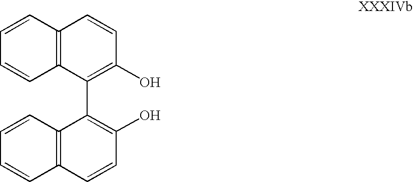

gives compound XXXVb below:

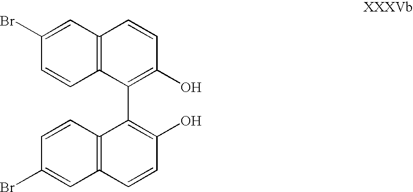

More generally, the hydroxyl groups present on the phenyl and naphthyl nuclei orient the electrophilic reaction such that the position of the bromine atoms on these nuclei is well defined.

The bromination reaction of phenyl or naphthyl nuclei is an electrophilic reaction which is readily performed by the action of Br₂ on the corresponding diol.

This reaction may be carried out in the presence of a catalyst such as a Lewis acid and in particular iron chloride. However, since the hydroxyl groups present on the phenyl and naphthyl nuclei activate these nuclei, the bromination is readily performed in the absence of any catalyst.

The diols of formula XXXIV are so reactive that it is desirable to carry out the bromination at low temperature, for example between −78° and −30° C. and preferably between −78 and −50° C.

According to one preferred embodiment of the invention, the bromination takes place in an inert aprotic solvent such as a haloaromatic hydrocarbon (for example chlorobenzene or dichlorobenzene); a nitroaromatic hydrocarbon such as a nitrobenzene; an optionally halogenated aliphatic hydrocarbon such as hexane, heptane, methylene chloride, carbon tetrachloride or dichloroethane; or an alicyclic hydrocarbon.

In general, aromatic hydrocarbons with electron-poor aromatic nuclei, i.e. nuclei bearing one or more electron-withdrawing substituents, may be used.

Preferred solvents which may be mentioned are haloaliphatic hydrocarbons and in particular methylene chloride.

As a variant, it is possible to perform the process in glacial acetic acid as solvent. Under these conditions, a solution of bromine in acetic acid is generally added dropwise to a solution of the diol XXXIV in acetic acid.

Whether the process is performed in the presence or absence of acetic acid, an excess of the brominating agent relative to the diol XXXIV is used.

Preferably, the molar ratio of the brominating agent to the diol XXXIV ranges between 2 and 5 and better still between 2 and 3.

When the process is performed in solution, the concentration of the reagents may vary within a very wide range between 0.01 and 10 mol/l, for example between 0.05 and 1 mol/l.

In step (ii), the hydroxyl functions of the diol XXXV are esterified by the action of a sulfonic acid or an activated form thereof, so as to obtain the corresponding disulfonate.

According to the invention, the nature of the sulfonic acid used is not a deciding factor per se.

Advantageously, the sulfonic acid has the formula:

P—SO₂—OH

in which P represents a hydrocarbon-based aliphatic group; an aromatic carbocyclic group; or an aliphatic group substituted with an aromatic carbocyclic group.

The expression “hydrocarbon-based aliphatic group” means in particular an alkyl group as defined above, which is optionally substituted. The nature of the substituent is such that it does not react under the conditions of the esterification reaction. A preferred example of a substituent for an alkyl group is a halogen atom such as fluorine, chlorine, bromine or iodine.

The expression “aromatic carbocyclic group” means mono- or polycyclic aromatic groups and in particular the mono-, bi- or tricyclic groups defined above, and for example phenyl, naphthyl, anthryl or phenanthryl.

The aromatic carbocyclic group is optionally substituted. The nature of the substituent is not critical provided that it does not react under the esterification conditions. Advantageously, the substituent is optionally halogenated alkyl, alkyl being as defined above and halogen representing chlorine, fluorine, bromine or iodine, and preferably chlorine. As an example, “optionally halogenated alkyl” denotes perfluoroalkyl such as trifluoromethyl or pentafluoroethyl.

According to one preferred embodiment of the invention, the sulfonic acid has the formula:

P—SO₂—OH

in which P represents (C₆-C₁₀)aryl optionally substituted with one or more optionally halogenated (C₁-C₆) alkyl; optionally halogenated (C₁-C₆) alkyl; or (C₆-C₁₀)aryl(C₁-C₆)alkyl in which the aryl group is optionally substituted with one or more optionally halogenated (C₁-C₆)alkyl and the alkyl group is optionally halogenated.

Suitable examples of such sulfonic acids are paratoluenesulfonic acid, methanesulfonic acid and trifluoromethanesulfonic acid, the latter being particularly preferred.

According to one preferred embodiment of the invention, an activated derivative of the sulfonic acid is used. The term “activated derivative” denotes a sulfonic acid in which the acid function —SO₃H is activated, for example by formation of an anhydride bond or an —SO₃Cl group.

One sulfonic acid derivative which is particularly advantageous is the symmetrical anhydride of trifluoromethanesulfonic acid, of formula (CF₃—SO₂)₂O. When the sulfonic acid has the formula P—SO₃H above or is an activated form of this acid, the disulfonate obtained after step ii) corresponds to formula XXXVII:

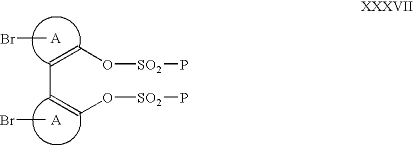

in which A and P are as defined above.

The conditions of the esterification reaction will be readily developed by those skilled in the art. These conditions depend in particular on the nature of the esterifying agent. When the esterifying agent is a sulfonic acid, a higher reaction temperature, of between 20 and 100° C., may prove to be necessary. Conversely, starting with an activated form of this acid, such as an anhydride or a sulfonyl chloride, a lower temperature may be suitable. Generally, a temperature of between −30° C. and 50° C. and preferably between −15° C. and 20° C. may suffice in this case.

The esterification is preferably carried out in a solvent. Suitable solvents are, in particular, optionally halogenated aliphatic, aromatic or cyclic hydrocarbons, such as those defined above. Mention may be made of carbon tetrachloride and dichloromethane. Dichloromethane is particularly preferred. Ethers may also be used as solvent. Mention will be made, for example, of C₁-C₆ dialkyl ethers (diethyl ether and diisopropyl ether), cyclic ethers (tetrahydrofuran and dioxane), dimethoxyethane and diethylene glycol dimethyl ether.

When the esterifying agent is an activated form of a sulfonic acid, it is desirable to introduce a base into the reaction medium. Examples of bases are N-methylmorpholine, triethylamine, tributylamine, diisopropylethylamine, dicyclohexylamine, N-methylpiperidine, pyridine, 2,6-dimethylpyridine, 4-(1-pyrrolidinyl)pyridine, picoline, 4-(N,N-dimethylamino)pyridine, 2,6-di-t-butyl-4-methylpyridine, quinoline, N,N-dimethylaniline and N,N-diethylaniline.

Preferred bases which will be essentially selected are pyridine and 4-dimethylaminopyridine.

The reaction may also be performed in a two-phase mixture of water and of an organic solvent such as a haloaliphatic hydrocarbon (for example carbon tetrachloride). In this case, it is preferable to use an esterifying agent in anhydride form and to perform the process in the presence of a water-soluble base such as KOH, NaOH or K₂CO₃, preferably KOH.

The reaction of the sulfonic acid or the activated derivative thereof with the bromo diol XXXV is stoichiometric. Nevertheless, it is preferable to perform the process in the presence of an excess of the acid or the activated form thereof. Thus, a ratio of the acid, optionally in activated form, to the diol XXXV of between 2 and 5 and better still between 2 and 3 is recommended.

When the reaction is performed in solutions the concentration of the reagents, which is not a critical parameter according to the invention, may range between 0.1 and 10 mol/l and advantageously between 1 and 5 mol/l.

Those skilled in the art may be inspired by the operating conditions illustrated in J. Org. Chem., vol. 58, No. 7, 1993, 1945-1948 and Tetrahedron Letters, vol. 31, No. 7, 985-988, 1990 for carrying out the esterification.

The following step (iii) is a nucleophilic substitution. The two bromine atoms borne by the nuclei A are displaced with cyano groups by the action of a suitable nucleophilic agent.

So as to perform this substitution, those skilled in the art may use any of the methods known in the art.

According to one preferred embodiment of the invention, the nucleophilic agent used is copper cyanide.

The molar ratio of the copper cyanide to the disulfonate is preferably greater than 2 and may advantageously range between 2 and 4 and preferably between 2 and 3.

The reaction is preferably carried out in a solvent. Examples of solvents which may be mentioned are amides such as formamide, dimethylformamide, dimethylacetamide, 2-N-methylpyrrolidinone and hexamethylphosphorylamide. Dimethylformamide is clearly preferred. Pyridine is also a suitable solvent. The reaction temperature is advantageously maintained between 50 and 200° C., for example between 70 and 190° C. and better still between 80 and 180° C.

A temperature which is more particularly suitable is between 100 and 190° C.

The concentration of the reagents in the reaction medium generally ranges between 0.1 and 10 mol/l, for example between 2 and 7 mol/l.

The isolation of the nitrile involves decomposing the intermediate complex formed and trapping the excess cyanide.

The hydrolysis of the intermediate complex may be performed either by the action of hydrated iron chloride or by the action of aqueous ethylenediamine.

In the first case, the reaction medium is poured into an aqueous 50-80% (g/ml) iron chloride solution containing concentrated hydrochloric acid. The resulting solution is heated at 40-80° C. until the complex has completely decomposed. The medium is then separated out by settling and extracted conventionally.

In the second case, the reaction medium is poured into an aqueous ethylenediamine solution (ethylenediamine/water: 1/5-1/1 (v/v), for example 1/3) and the mixture is then stirred vigorously. The medium is then separated by settling of the phases and extracted in a manner which is known per se.

Those skilled in the art may be inspired by the work of L. Friedman et al. published in J.O.C. 1961, 26, 1522, for isolating the nitrile.

Starting with the disulfonate of formula XXXVII mentioned above, the product obtained at the end of this step is the nitrile of formula XXXVIII:

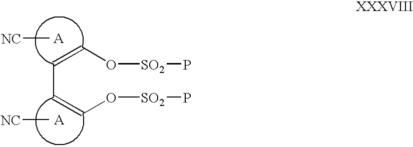

in which A and P are as defined above and the position of the cyano group on the nucleus A is the same as that of the bromine in compound XXXVII.

In the following step (iv), a cross-coupling of a phosphine of formula XXXVI:

XPAr₁Ar₂ XXXVI

in which X is a halogen or hydrogen atom and Ar₁ and Ar₂ are as defined above, is carried out with the nitrile obtained in the above step, in the presence of a catalyst based on a transition metal.

Examples of catalysts suitable for carrying out this step are catalysts based on nickel, palladium, rhodium, ruthenium or platinum or on a mixture of these metals.

The preferred catalysts are nickel-based catalysts such as those chosen from NiCl₂; NiBr₂; NiCl₂(dppp); NiCl₂(dppb); NiCl₂ (dppf); NiCl₂(dppe); NiCl₂(PPh₃)₂; Ni(CO)₂(PPh₃)₂; Ni(PPh₃)₄ and Ni[P(PhO)₃]₄ in which dppe means (diphenylphosphino)ethane, dppp means (diphenylphosphino)propane, dppb means (diphenylphosphino)butane and dppf means (diphenylphosphino)ferrocenyl.

Among these catalysts, NiCl₂(dppe) is preferred.

The reaction is generally carried out at a temperature of from 50 to 200° C. and preferably from 80 to 130° C.

The molar ratio of compound XXXVI to the nitrile is at least 2. It generally ranges between 2 and 4, for example between 2 and 3.

The amount of catalyst is preferably such that the molar ratio of the nitrile to the catalyst ranges between 5 and 100 and in particular between 5 and 80.

The reaction is preferably performed in a polar aprotic solvent and in particular an amide such as those mentioned above. In this case also, N,N-dimethylformamide is preferred. Nevertheless, other types of polar solvent may be used, such as (C₁-C₆)alkanols (ethanol), aromatic hydrocarbons (toluene, xylene and benzene), ethers (dioxane) and acetonitrile.

The precise reaction conditions depend on the nature of the compound of formula XXXVI involved in the reaction.

When compound XXXVI is HPAr₁Ar₂, the reaction is advantageously performed in the presence of a base.

Bases that are particularly suitable are pyridine, 4-dimethylaminopyridine, 2,6-di-tert-butylpyridine, 1,8-diazabicyclo[5.4.0]undec-7-ene (DBU), 1,5-diazabicyclo[4.3.0]non-5-ene (DBN) and 1,4-diazabicyclo[2.2.2]octane (DABCO or triethylenediamine). DABCO will advantageously be used as base. In this case, it is preferred for the molar ratio of the nitrile to the catalyst to be between 5 and 20, for example between 7 and 15.

When the compound of formula XXXVI is halPAr₁Ar₂ in which hal is a halogen atom, preferably Cl or Br (better still Cl), it is necessary to add zinc to the reaction medium.

The amount of zinc is preferably such that the molar ratio of the zinc to the halPAr₁AR₂ ranges between 1 and 2 and preferably between 1.2 and 1.7.

In this case, it is desirable to cool the reaction mixture containing the solvent, the nitrile and compound XXXVI to a temperature of between −10° C. and 20° C. throughout the addition of the zinc to the reaction medium. Then, the reaction takes place by heating to a suitable temperature of between 50° C. and 200° C.

When the compound of formula XXXVI is halPAr₁Ar₂, it is preferred for the molar ratio of the nitrile to the catalyst to be between 40 and 80, for example between 50 and 70.

For further details regarding the implementation of these coupling reactions, those skilled in the art will refer to D. Cai et al. J.O.C. 1994, 59, 7180 and D. J. Ager et al. Chem. Comm. 1997, 2359.

When A represents phenyl which is optionally substituted, preferably with (C₁-C₆) alkyl or (C₁-C₆)alkoxy, the compound obtained after step (iv) has the formula XXXIXa:

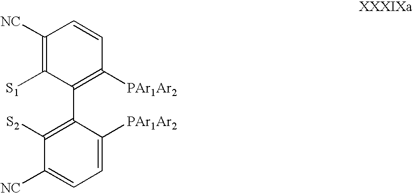

in which Ar₁, Ar₂, S₁ and S₂ are as defined above for formula XXXIVa.

When A represents naphthyl, the compound obtained after step (iv) has the formula XXXIXb:

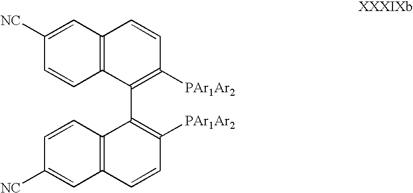

in which Ar₁ and Ar₂ are as defined above.

In step v), a suitable reducing agent is lithium aluminum hydride (LiAlH₄). However, the use of another type of reducing agent is not excluded.

The reaction is preferably carried out in a solvent or a mixture of solvents.

When the reducing agent is LiAlH₄, the solvent advantageously comprises one or more aromatic hydrocarbons (such as benzene, toluene or xylene) mixed with one or more ethers.

Ethers which may be mentioned are C₁-C₆ alkyl ethers (diethyl ether and diisopropyl ether), cyclic ethers (dioxane and tetrahydrofuran), dimethoxyethane and diethylene glycol dimethyl ether.

Cyclic ethers such as tetrahydrofuran are preferred.

When the reducing agent is LiAlH₄, a mixture of toluene and tetrahydrofuran in proportions ranging between (v/v) 70-50/30-50:toluene/tetrahydrofuran (for example 60/40:toluene/THF) will be chosen more preferably.

The reduction may be carried out at a temperature of between 20° C. and 100° C. and preferably between 40° C. and 80° C.

A large excess of the reducing agent is usually used. Thus, the molar ratio of the reducing agent to the compound of formula I generally ranges between 1 and 30, for example between 2 and 20 and in particular between 5 and 18.

The concentration of the reagents in the medium is variable; it may be maintained between 0.005 and 1 mol/l.

The compounds of formula I thus obtained allow the preparation of the compounds α by carrying out conventional methods of organic chemistry.

When it is a matter of preparing a polyoxyalkylene derivative (i) containing a group G₁ and/or G₂ at the end of a linear polyoxyalkylene chain, one of the synthetic methods illustrated below may be used as inspiration.

In general, a linear polyoxyalkylene containing a reactive end (the other end optionally being protected with a suitable protecting group) is reacted with a molecule capable of reacting with said reactive end and moreover bearing a latent function capable of reacting, optionally after suitable activation, with an amino group; next, where appropriate, after activation of said latent function, the compound obtained is reacted with a compound of formula I as defined above.

The expression “latent function” means a function capable of reacting with an amino group or a function that may be readily converted into a reactive function so as to react it with an amino group.

Advantageously, the reactive function comprises a free carboxylic group —COOH or an activated carboxylic group of formula —CO-T in which T is an activating group. Preferred activating groups are well known in the prior art, such as, for example, halogen (chlorine or bromine), azide, imidazolide, p-nitrophenoxy, 1-benzotriazole, O—N-succinimide, acyloxy and, more particularly, pivaloyloxy, alkoxycarbonyloxy such as, for example, C₂H₅OCO—O—, or dialkyl- or dicycloalkyl-O-ureide.

A series of suitable methods for preparing activated carboxylic acid-derivatives is proposed by J. March in Advanced Organic Chemistry, published by John Wiley & Sons.

When the latent function comprises a free carboxyl function, it is desirable to carry out its reaction with the amino group(s) of the compound of formula I in the presence of an activating agent such as, for example, dicyclohexylcarbodiimide (DCC) or O-[(cyano(ethoxycarbonyl)methylene)amino]-1,1,3,3-tetramethyluronium tetrafluoroborate (TOTU). Reference may be made, for example, to Proceedings of the 21 European Peptide Symposium, Peptides, 1990, E. Giralt and D. Andreu editors, Escom, Leiden, 1991.

In schematic terms, POA-Fo represents the intermediate compound bearing the reactive function capable of reacting with the amino group. In this formula, POA denotes a polyoxyalkylene and Fo a function capable of reacting with an amino group.

Preferred examples of this compound POA-Fo are as follows:

POA-N═C═O III

POA-O—CO—CH₂—CH₂—CO—O-Nsu IV

POA-O—CH₂—CH₂—CO—O-Nsu V

POA-O—CO—NH—CH(L)-CO—O—-Nsu VI 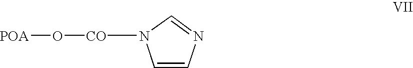
POA-O—CH₂—CO—O-Nsu VIII

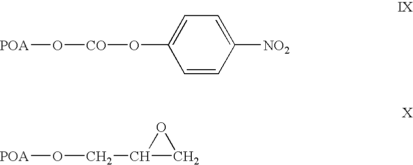

In these formulae -Nsu denotes the group

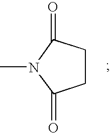

and POA denotes a polyoxyalkylene group of formula

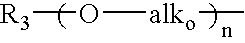

in which R₃ and n are as defined above and alk₀ represents linear or branched alkylene, preferably of C₂-C₁₀ and better still C₂-C₆, for example of C₂-C₃.

Method A

This method illustrates the preparation of a compound of formula III.

The reaction steps carried out are given in scheme 1 below.

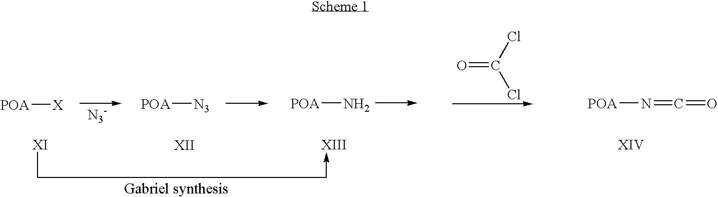

In this scheme, POA is as defined above. In a first step, a linear polyoxyalkylene bearing a leaving group X at one of its ends (for example a halogen atom, an optionally substituted arylsulfonyloxy function, such as tosyloxy, or an optionally substituted alkylsulfonyloxy function such as mesyloxy) is reacted with an azide ion (derived, for example, from an alkali metal azide).

The resulting azide is reduced either by catalytic hydrogenation or by the action of a hydride such as sodium borohydride or lithium aluminum hydride, so as to give the amino derivative XIII.

As a variant, the intermediate compound of formula XI may be converted into the amino derivative XIII by means of the Gabriel synthesis. In this case, the compound of formula XI is treated with an alkali metal phthalimide or an alkali metal succinimide and the resulting compound is then hydrolyzed, for example by the action of a base such as a hydroxide. The Gabriel synthesis is described especially in Angew. Chem. Int. Ed. Engl. 7, 919-930 (1968).

The next step consists in reacting the resulting amino derivative, of formula XIII, with phosgene. Said step involves a standard reaction for preparing an isocyanate. To do this, a person skilled in the art may refer to Chem. Soc. Rev. 3, 209-230 (1974).

Method B

This method illustrates the synthesis of a compound of formula III in which POA denotes a polyethylene glycol (PEG).

Scheme 2 below illustrates the corresponding synthetic route.

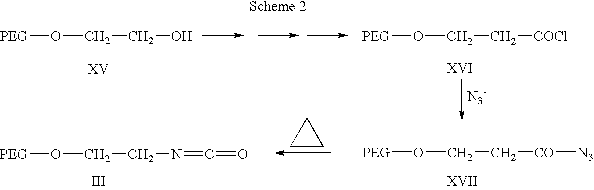

In a first stage, a polyethylene glycol of formula XV containing a free —OH end (and the other end of which is optionally protected with a suitable protecting group) is converted into the acid chloride of formula XVI. This conversion may be performed simply by carrying out the following sequence of reactions:

the terminal hydroxyl function of the compound XV is converted into a leaving group, for example into a halogen atom, into an optionally substituted arylsulfonyloxy (tosyloxy) function or into an optionally substituted alkylsulfonyloxy (mesyloxy) function;

the resulting compound is reacted with a cyanide ion (for example originating from alkali metal cyanide) under the standard conditions recommended in the art for the preparation of nitrites;

the hydrolysis of the nitrile derivative thus obtained gives the corresponding carboxylic acid.

The conditions for carrying out this reaction also form part of the knowledge of a person skilled in the art;

the carboxylic acid is then converted conventionally into the corresponding acid chloride (for example by the action of SOCl₂).

The next step consists in reacting the carboxylic acid obtained of formula XVI with an azide such as an alkali metal azide.

Pyrolysis of the resulting acyl azide, of formula XVII, gives the corresponding isocyanate by means of a Curtius rearrangement under the usual conditions prescribed in the literature. Reference may be made, for example, to Banthorpe, “The chemistry of the Azido Group”, pp. 397-405, Interscience, New York, 1971.

Method C

This method illustrates the preparation of a compound of formula IV.

The reaction scheme proposed is as follows:

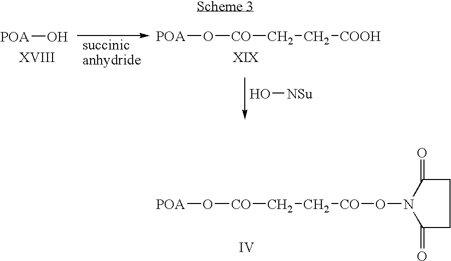

In this scheme, NSu denotes the N-succinimidyl group and POA a polyoxyalkylene as defined above.

In a first step, the terminal hydroxyl group of a polyoxyalkylene (the other end of which is optionally protected with a suitable protecting group) is reacted with succinic anhydride, and the resulting compound of formula XIX is isolated. This reaction is carried out under the standard conditions of organic chemistry.

The desired compound of formula IV is obtained by reacting the acid XIX with N-hydroxysuccinimide, where appropriate after activating the carboxylic acid function. An activation of the carboxylic function may be obtained, for example, in the presence of carbodiimides such as dicyclohexylcarbodiimides and diisopropylcarbodiimides.

Method D

Preparation of a compound of formula V in which POA represents a polyethylene glycol (PEG) chain.

A synthetic variant is illustrated especially in Scheme 4.

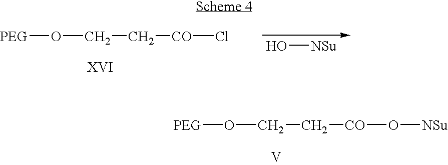

Reaction of N-hydroxysuccinimide with the acid chloride of formula XVI gives the desired compound V. This reaction uses the usual conditions known to those skilled in the art. The process is performed especially in the presence of a base, preferably an organic base. Suitable bases, are, for example, N-methylmorpholine, triethylamine, tributylamine, diisopropylethylamine, dicyclohexylamine, N-methylpiperidine, pyridine, 4-(1-pyrrolidinyl)pyridine, picoline, 4-(N,N-dimethylamino)pyridine, 2,6-di-t-butyl-4-methylpyridine, quinoline, N,N-dimethylamine, N,N-diethylaniline, 1,8-diazabicyclo[5.4.0]undec-7-ene (DBU), 1,5-diazabicyclo[4.3.0]non-5-ene (DBN) and 1,4-diazabicyclo[2.2.2]octane (DABCO or triethylenediamine).

Pyridine or triethylamine is more particularly used.

Method E

Preparation of a compound of formula VI in which POA represents a polyethylene glycol (PEG) chain.

Scheme 5 illustrates a typical synthetic variant.

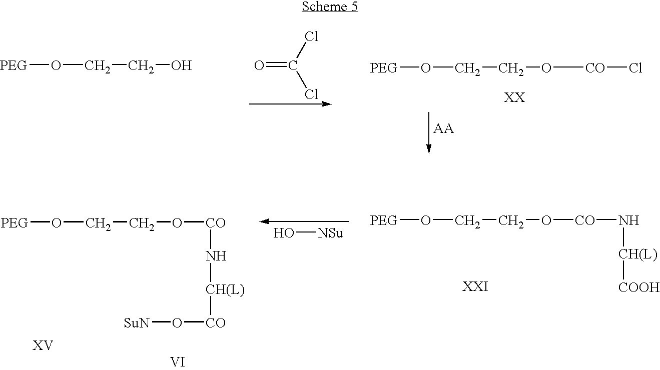

In scheme 5, PEG is as defined above, AA denotes an α-amino acid of formula H₂N—CH(L)-COOH and —NSu denotes the N-succinimidyl group.

In a first step, phosgene is reacted with the terminal hydroxyl function of a polyethylene glycol, the other end of which is optionally protected with a suitable protecting group. This reaction gives, under the standard conditions, compound XX.

In a second step, the carboxylic acid chloride XX is reacted with an α-amino acid in which, where appropriate, the reactive functions other than the amino function have been protected.

The resulting compound XXI is then esterified by the action of N-hydroxysuccinimide, optionally in the presence of a suitable activator such as a carbodiimide. Examples of carbodiimides are dicyclohexylcarbodiimides and diisopropylcarbodiimides.

The protecting functions are removed before or after reaction with the N-hydroxysuccinimide, depending on the case.

Method F

Preparation of a compound of formula VII in which POA represents a polyethylene glycol (PEG) chain.

Scheme 6 represents a suitable synthetic method.

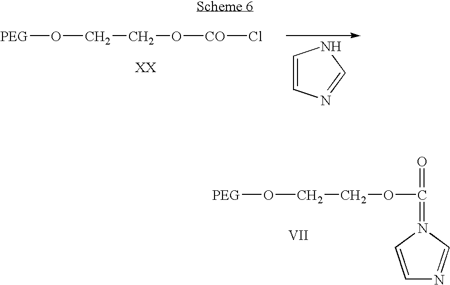

The reaction of compound XX, the synthesis of which has been described above (scheme 5), with imidazole gives, under the usual conditions (and especially in the presence of a base), the desired compound VII. The base is preferably an organic base as defined above in method D, more particularly pyridine or triethylamine.

Method G

Preparation of a compound of formula VIII in which POA denotes a polyethylene glycol (PEG).

Scheme 7 illustrates the synthesis proposed for this compound.

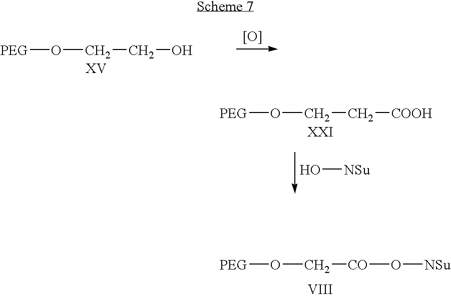

NSu and PEG are as defined above. The terminal —CH₂—OH function of a polyethylene glycol, the other end of which is optionally protected, is first conventionally oxidized to a carboxyl function.

The resulting compound of formula XXI is reacted with N-hydroxysuccinimide to give the expected compound of formula VIII. The reaction conditions are similar to those used in the case of converting compound XIX into compound IV (scheme 3).

Method H

Preparation of a compound of formula IX in which POA denotes a polyethylene glycol (PEG).

Scheme 8 gives a simple synthetic variant.

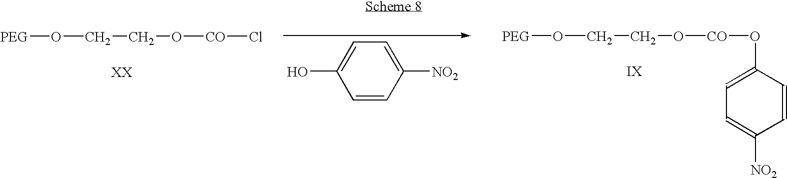

The reaction of the acid chloride XX, the preparation of which has been described above, with paranitrophenol is carried out under the standard conditions and gives the expected compound of formula IX. The process is performed especially in the presence of an organic base as defined above, and more particularly triethylamine or pyridine.

Method I

Preparation of a compound of formula X. To do this, reference may be made, for example, to scheme 9 below:

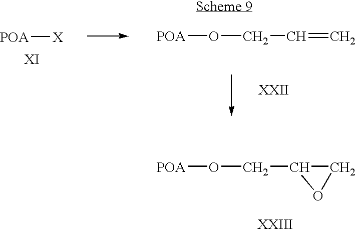

In a first step, a linear polyoxyalkylene bearing a leaving group X at one of its ends (such as a halogen atom, an optionally substituted arylsulfonyloxy group tosyloxy—or an optionally substituted alkylsulfonyloxy group—mesyloxy) and the other end of which is optionally protected with a protecting group, is reacted with allyl alcohol under the usual conditions of a nucleophilic substitution.

Next, the resulting compound is epoxidized, for example by the action of a peracid such as metachloroperbenzoic acid, perbenzoic acid or peracetic acid.

To carry out methods A to G above, it is possible to protect one of the ends of the polyoxyalkylene or polyethylene glycol used as starting material.

Examples of suitable protecting groups are alkoxy groups (and especially methoxy or ethoxy).

It will be noted that compounds III to X above are generally commercially available.

Whatever the case, their synthesis is readily carried out, as illustrated above, and involves known methods of organic chemistry. The intermediate compounds III to X above each bear a function capable of reacting with an amino group.

The reaction of these compounds with a compound of formula I thus gives the expected polyoxyalkylene derivative (i).

The operating conditions for this last reaction depend on the type of compound POA-Fo.

The reaction may be performed without solvent or in the presence of a solvent. In this case, a polar aprotic solvent is preferred.

A suitable solvent is a halogenated aliphatic hydrocarbon (such as dichloromethane or trichloroethylene) or a halogenated aromatic hydrocarbon (such as halobenzene or halotoluene).

The reaction temperature depends on the reactivity of the function Fo. It generally ranges between room temperature and the reflux point of the reaction medium.

It goes without saying that the respective amounts of compounds of formula I and of the intermediate POA-Fo used in this reaction depend on the intended structure of the intermediate polyoxyalkylene derivative (i).

When (i) comprises a group G₁, less than one molar equivalent of the compound POA-Fo will preferably be used.

When (i) comprises a group G₂, at least two molar equivalents of the compound POA-Fo will preferably be used.

When the groups G₁ and/or G₂ are linked to the end of a polyoxyalkylene side chain, the synthesis of the polyoxyalkylene derivative (i) will be performed simply by a person skilled in the art starting with commercial compounds.

The polyoxyalkylene derivatives (i) in which the NH groups of the groups G₁ and/or G₂ are linked to an internal unit of the polyoxyalkylene chain via a bridging chain, may be prepared by carrying out a method similar to method J proposed below, which illustrates more specifically the case of a bridging chain of formula alk-CO—, in which —CO— is linked to the NH function of the groups G₁ and/or G₂ and alk is directly linked to the polyoxyalkylene chain. It should be understood that alk is as defined above.

Method J

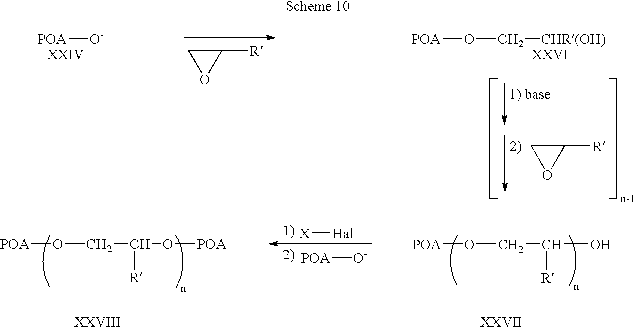

In this scheme, R′ represents

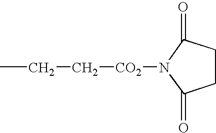

The anion XXIV is prepared simply by reacting the terminal hydroxyl function of a polyoxyalkylene, the other end of which is optionally protected with a suitable protecting group, with a base.

Examples of suitable organic bases are N-methylmorpholine, triethylamine, tributylamine, diisopropylethylamine, dicyclohexylamine, N-methylpiperidine, pyridine, 4-(1-pyrrolidinyl)pyridine, picoline, 4-(N,N-dimethylamino)pyridine, 2,6-di-t-butyl-4-methylpyridine, quinoline, N,N-dimethylaniline and N,N-diethylaniline.

Examples of suitable mineral bases are NaOH, KOH, NaHCO₃, Na₂CO₃, KHCO₃, K₂CO₃ and NaH.

The resulting anion then reacts with the epoxide XXV, bringing about opening of the epoxide and the formation of the alcohol XXVI.

Said alcohol is again subjected to the action of a base, and the alkoxide obtained is again reacted with the epoxide XXV.

These last two steps are repeated as many times as necessary.

Next, the alcohol of formula XXVII is reacted with a derivative X-Hal in which X represents arylsulfonyloxy (tosyloxy) of alkylsulfonyloxy (mesyloxy) and Hal represents a halogen atom.

The resulting compound reacts with an alkoxide of type XXIV to give the desired compound of formula XXVIII.

Compound XXVIII leads readily to the polyoxyalkylene derivative (i) by reaction with a compound of formula I, the functions —CO₂—NSu of this compound reacting with the aminomethyl functions of compound I.

The reaction conditions for this last reaction are similar to those indicated above for the reaction of POA-Fo with compound I. However, it will be noted that, since compound XXVII comprises n —CO₂NSu functions, it will be possible to graft up to n groups G₁ and/or G₂ onto the polyoxyalkylene chain.

The water-soluble compounds of the invention may be used as ligands in the preparation of water-soluble metal complexes that are suitable for the asymmetric catalysis of hydrogenation reactions, hydrosilylation reactions, hydroboration reactions of unsaturated compounds, epoxidation reactions of allylic alcohols, vicinal hydroxylation reactions, hydrovinylation reactions, hydroformylation reactions, cyclopropanation reactions, isomerization reactions of olefins, polymerization reactions of propylene, addition reactions of organometallic compounds to aldehydes, allylic alkylation reactions, reactions of aldol type, Diels-Alder reactions and, in general, reactions for the formation of C—C bonds (such as allylic substitutions or Grignard cross-couplings).

A mixture of compounds of formula a may also be used as ligand. A compound of formula II and its corresponding monopolyoxyalkylene derivative may especially be used.

According to one preferred embodiment of the invention, the complexes are used for the hydrogenation of C═O, C═C and C═N bonds.

The complexes which may be used in reactions of this type are rhodium, ruthenium, palladium, platinum, iridium, cobalt, nickel or rhenium complexes, preferably rhodium, ruthenium, iridium, palladium and platinum complexes. Even more advantageously, rhodium, ruthenium or iridium complexes are used.

According to another of its aspects, the invention relates to complexes of the water-soluble ligands of formula α. Preferred complexes are those of rhodium, ruthenium or iridium.

Specific examples of said complexes of the present invention are given below, with no limiting nature.

In the following formulae, P represents a ligand according to the invention.

A preferred group of the rhodium and iridium complexes is defined by the formula:

[MeLig₂P]Y_{I} XXX

in which:

P represents a ligand according to the invention;

Y_{I} represents a coordinating anionic ligand;

Me represents iridium or rhodium; and

Lig represents a neutral ligand.

Among these compounds, those in which:

Lig represents an olefin containing from 2 to 12 carbon atoms;

Y_{I} represents a PF₆⁻, PCl₆⁻, BF₄⁻, BCl₄⁻, SbF₆⁻, SbCl₆⁻, BPh₄⁻, B (C₆F₅)₄⁻, ClO₄⁻, CN⁻, CF₃SO₃⁻ or halogen, preferably Cl⁻ or Br⁻, anion, a 1,3-diketonate, alkylcarboxylate or haloalkylcarboxylate anion with a lower alkyl (preferably C₁-C₆) radical, a phenylcarboxylate or phenoxide anion in which the benzene ring may be substituted with lower alkyl (preferably C₁-C₆) radicals and/or halogen atoms, are particularly preferred.

In formula XXX, Lig₂ may represent two Lig ligands as defined above or a bidentate ligand such as a linear or cyclic, polyunsaturated bidentate ligand comprising at least two unsaturations.

It is preferred according to the invention for Lig₂ to represent 1,5-cyclooctadiene, norbornadiene or for Lig to represent ethylene.

The expression “lower alkyl radicals” generally means a linear or branched alkyl radical containing from 1 to 4 carbon atoms.

Other iridium complexes are those of formula:

[IrLigP]Y_{I} XXXI

in which Lig, P and Y_{I} are as defined for formula XXX.

A preferred group of ruthenium complexes consists of the compounds of formula:

[RuY_{I}¹Y_{I}²P] XXXII

in which:

P represents a ligand according to the invention;

Y_{I}¹ and Y_{I}², which may be identical or different, represent a PF₆⁻, PCl₆⁻, BF₄⁻, BCl₄⁻, SbF₆⁻, SbCl₆⁻, BPh₄⁻, ClO₄— or CF₃SO₃— anion, a halogen atom, more particularly chlorine or bromine, or a carboxylate anion, preferably acetate or trifluoroacetate;

m is a non-zero integer greater than 1;

it being understood that when m is 1, then Y_{I}¹ and/or Y_{I}² can also represent B(C₆F₅)₄—.

When m=1, the complex XXXII is a monomer.

When m=2, the complex XXXII is a dimer.

When m is greater than 2, the complex XXXII is a polymer.

Other ruthenium complexes are those corresponding to formula XXXIII below:

[RuY₁³arPY_{I}⁴] XXXIII

in which:

P represents a ligand according to the invention;

ar represents benzene, p-methylisopropylbenzene or hexamethylbenzene;

Y_{I}³ represents a halogen atom, preferably chlorine or bromine;

Y_{I}⁴ represents an anion, preferably a PF₆⁻, PCl₆⁻, BF₄⁻, BCl₄⁻, B(C₆F₅)₄⁻, SbF₆⁻, SbCl₆⁻, BPh₄⁻, ClO₄⁻ or CF₃SO₃⁻ anion.

It is also possible to use in the process of the invention palladium-based and platinum-based complexes.

As more specific examples of said complexes, mention may be made, inter alia, of Pd(hal)₂P and Pt(hal)₂P in which P represents a ligand according to the invention and hal represents halogen such as, for example, chlorine.

The complexes comprising a ligand according to the invention and the transition metal may be prepared according to the known processes described in the literature.

The complexes are generally prepared from a precatalyst whose nature varies according to the transition metal selected.

In the case of rhodium complexes, the precatalyst is, for example, one of the following compounds: [Rh_{I}(CO)₂Cl]₂; [Rh^{I}(COD)₂Cl]₂ in which COD denotes cyclooctadiene; or Rh^{I}(acac)(CO)₂ in which acac denotes acetylacetonate.

In the case of ruthenium complexes, precatalysts that are particularly suitable are bis(2-methylallyl)cycloocta-1,5-dieneruthenium and [RuCl₂(benzene)]2. Mention may also be made of Ru(COD)(η³—(CH₂)₂CHCH₃)₂.

By way of example, starting with bis(2-methylallyl)cycloocta-1,5-dieneruthenium, a solution or suspension is prepared containing the metallic precatalyst, a ligand and a fully degassed solvent such as acetone (the ligand concentration in the solution or suspension ranging between 0.001 and 1 mol/l), to which is added a methanolic hydrogen bromide solution. The ratio of the ruthenium to the bromine advantageously ranges between 1:1 and 1:4 and preferably between 1:2 and 1:3. The molar ratio of the ligand to the transition metal is itself about 1. It may be between 0.8 and 1.2.

When this method is used, it is possible to perform the salification of a compound of formula I and the complexation of the resulting salt with ruthenium simultaneously. To do this, it suffices to carry out the complexation under the conditions described above, starting directly with a diaminomethyl compound of formula I.

Similarly, the direct preparation of the catalyst complex from a compound of formula I may be envisaged by salification and simultaneous complexation. To do this, it suffices to perform the complexation reaction starting with the suitable precursor complex in the presence of an organic or mineral acid.

Thus, rhodium, ruthenium, palladium, platinum, iridium, cobalt, nickel or rhenium complexes, and more generally complexes of transition metals, may be prepared.

When the precatalyst is [RuCl₂(benzene)]₂, the complex is prepared by mixing the precatalyst, the ligand and an organic solvent and the reaction medium is maintained at a temperature of between 15° C. and 150° C. for 1 minute to 24 hours, preferably 30° C. to 120° C. for 10 minutes to 5 hours.

Solvents which may be mentioned are aromatic hydrocarbons (such as benzene, toluene and xylene), amides (such as formamide, dimethylformamide, dimethylacetamide, 2-N-methylpyrrolidinone or hexamethylphosphorylamide) and alcohols (such as ethanol, methanol, n-propanol and isopropanol), and mixtures thereof.

Preferably, when the solvent is an amide, in particular dimethylformamide, the mixture of the ligand, the precatalyst and the solvent is heated to between 80° C. and 120° C.

As a variant, when the solvent is a mixture of an aromatic hydrocarbon (such as benzene) with an alcohol (such as ethanol), the reaction medium is heated to a temperature of between 30° C. and 70° C.

The catalyst is then recovered according to the conventional techniques (filtration or crystallization) and used in asymmetric reactions. Nevertheless, the reaction which needs to be catalyzed with the complex thus prepared may be carried out without intermediate isolation of the catalyst complex.

In the text hereinbelow, the case of hydrogenation (typical example of a reaction that is advantageously catalyzed with the complexes of the invention) is described in detail.

The unsaturated substrate, dissolved in a solvent comprising the catalyst, is placed under a pressure of hydrogen.

The hydrogenation is carried out, for example, at a pressure ranging between 1.5 bar and 100 bar, and at a temperature of between 20° C. and 100° C.

The exact implementation conditions depend on the nature of the substrate which needs to be hydrogenated. Nevertheless, in the general case, a pressure of from 20 bar to 80 bar and preferably from 30 bar to 50 bar, and a temperature of from 30° C. to 70° C., are particularly suitable.

Since the complexes of the invention are water-soluble, the hydrogenation reaction is carried out either in aqueous or single-phase aqueous-organic medium, or in two-phase aqueous-organic medium.

When the substrate is water-soluble or soluble in a water-miscible organic solvent in the proportions necessary to dissolve the substrate, the hydrogenation reaction is performed in one-phase medium.

Water-miscible organic solvents that are suitable are dimethylformamide and C₁-C₄ aliphatic alcohols such as methanol or propanol.

When the substrate is not soluble in one of these solvents or is not water-soluble, the hydrogenation reaction is performed in two-phase medium. The substrate may be dissolved in an organic solvent which is generally an aliphatic, saturated cyclic or aromatic hydrocarbon. Examples of suitable solvents are cyclohexane and toluene.

The ratio of the respective phases in the two-phase medium may be of any proportion. Preferably, the ratio of the organic phase to the aqueous phase is maintained between 0.5:1 and 5:1 and preferably between 1:1 and 3:1.

As a variant, the substrate acts by itself as the organic phase.

The molar ratio of the substrate to the catalyst generally ranges from 1/100 to 1/100 000 and preferably from 1/20 to 1/2 000. This ratio is, for example, 1/1 000.

The rhodium complexes prepared from the ligands of the invention are more especially suitable for the asymmetric catalysis of isomerization reactions of olefins.

The removal of the catalyst from the reaction medium is facilitated by the intrinsic water-solubility or structure characteristics of the catalyst.

When the asymmetric reaction (for example the hydrogenation reaction) is carried out in two-phase medium, the catalyst is simply removed by separation of the aqueous phase. When the asymmetric reaction (for example the hydrogenation reaction) is carried out in aqueous or aqueous-organic one-phase medium, the catalyst is separated from the reaction medium by nanofiltration.

The technique of nanofiltration is more particularly suitable in the case of catalysts of polymeric type. The application of this technique is illustrated, for example, in Tetrahedron: Asymmetry, vol. 8, No. 12, 1975-1977, 1997.

According to one preferred embodiment of the invention, the complex of the invention is used in combination with a water-soluble additive that may be a water-soluble amine, a polyoxyalkylene such as a polyethylene glycol, or a corresponding monoalkyl or dialkyl ether thereof.

The enantioselectivity of the catalytic reaction may thus be improved.

The polyoxyalkylenes that may be used preferably contain at least 20, better still from 20 to 150, for example from 50 to 120, oxyalkylene units.

For a value of the number of oxyalkylene units of between 20 and 150, the molar mass of the polyoxyalkylene is between 1 000 and 9 000.

For a value of the number of oxyalkylene units of between 50 and 120, the molar mass of the polyoxyalkylene is between 3 000 and 7 000.

Preferably, the polyoxyalkylene is a polyethylene glycol.

Monoalkyl or dialkyl ethers that may be mentioned include (C₁-C₁₀)alkyl ethers and especially (C₁-C₆)alkyl ethers. More particularly, the methyl and ethyl ethers are preferred. It should be understood that the alkyl radical is as generally defined above.

As water-soluble additive that may be used, mention may be made of the compounds described in the following references:

Sendler J. H., Membran Mimetic Chem., 1982, Wiley & Sons, N.Y.,

Benton C. A., Savelli G., Adv. Phys. Org Chem., 1986, 22, p. 213, which are known to positively influence the enantioselectivity of organic reactions owing to their ability to promote the formation of micellar systems,

Oehme G., Peatzold E., Selke R., J. Mol. Catal., 1992, 71, more particularly describes compounds that favorably influence asymmetric hydrogenation with rhodium complexes.

The ruthenium complexes prepared from the ligands of the invention are more especially suitable for the asymmetric catalysis of hydrogenation reactions of carbonyl bonds, of C═C bonds and of C═N bonds.

As regards the hydrogenation of double bonds, the suitable substrates are of the type such as α,β-unsaturated carboxylic acid and/or α, β-unsaturated carboxylic acid derivatives. These substrates are described in EP 95943260.0.

The α,β-unsaturated carboxylic acid and/or the derivative thereof corresponds more particularly to formula A:

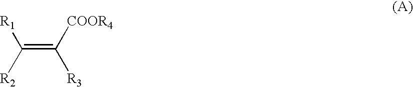

in which:

R₁, R₂, R₃ and R₄ represent a hydrogen atom or any hydrocarbon-based group, provided that:

if R₁ is different than R₂ and other than a hydrogen atom, then R₃ can be any hydrocarbonbased group or functional group denoted by R,

if R₁ or R₂ represents a hydrogen atom and if R₁ is other than R₂, then, R₃ is other than a hydrogen atom and other than —COOR₄,

if R₁ is identical to R₂ and represents any hydrocarbon-based group or functional group denoted by R, then R₃ is other than —CH—(R)₂, and other than —COOR₄,

one of the groups R₁, R₂ and R₃ possibly representing a functional group.

A specific example which may be mentioned, inter alia, is 2-methyl-2-butenoic acid.

A first group of preferred substrates is formed by substituted acrylic acids that are precursors of amino acids and/or derivatives.

The expression “substituted acrylic acids” means the set of compounds whose formula is derived from that of acrylic acid by substituting not more than two of the hydrogen atoms borne by the ethylenic carbon atoms with a hydrocarbon-based group or with a functional group.

They may be symbolized by the following chemical formula:

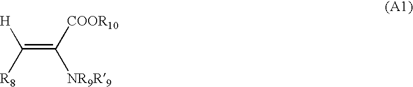

in which:

R₉ and R′₉, which may be identical or different, represent a hydrogen atom, a linear or branched alkyl group containing from 1 to 12 carbon atoms, a phenyl group or an acyl group containing from 2 to 12 carbon atoms, and preferably an acetyl or benzoyl group,

R₈ represents a hydrogen atom, an alkyl group containing from 1 to 12 carbon atoms, a cycloalkyl radical containing from 3 to 8 carbon atoms, an arylalkyl radical containing from 6 to 12 carbon atoms, an aryl radical containing from 6 to 12 carbon atoms or a heterocyclic radical containing from 4 to 7 carbon atoms,

R₁₀ represents a hydrogen atom or a linear or branched alkyl group containing from 1 to 4 carbon atoms.

Mention may be made more particularly of:

methyl α-acetamidocinnamate,

methyl acetamidoacrylate,

benzamidocinnamic acid,

α-acetamidocinnamic acid.

A second preferred group of substrates consists of itaconic acid and derivatives thereof of formula:

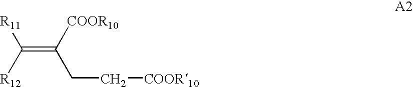

in which:

R₁₁ and R₁₂, which may be identical or different, represent a hydrogen atom, a linear or branched alkyl group containing from 1 to 12 carbon atoms, a cycloalkyl radical containing from 3 to 8 carbon atoms, an arylalkyl radical containing from 6 to 12 carbon atoms, an aryl radical containing from 6 to 12 carbon atoms, a heterocyclic radical containing from 4 to 7 carbon atoms,

R₁₀ and R′₁₀, which may be identical or different, represent a hydrogen atom or a linear or branched alkyl group containing from 1 to 4 carbon atoms.

As more specific examples, mention may be made in particular of itaconic acid and dimethyl itaconate.

A third preferred group of substrates is defined by formula A3:

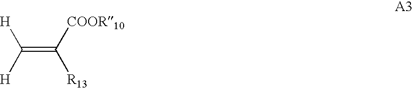

in which:

R″₁₀ represents a hydrogen atom or a linear or branched alkyl group containing from 1 to 4 carbon atoms,

R₁₃ represents a phenyl or naphthyl group optionally bearing one or more substituents.

Specific examples which may be mentioned are the substrates leading by hydrogenation to 2-(3-benzoylphenyl)propionic acid (Ketoprofen®), 2-(4-isobutylphenyl)propionic acid (Ibuprofen®) and 2-(5-methoxynaphthyl)propionic acid (Naproxen®)

As regards the hydrogenation of carbonyl bonds, the appropriate substrates of ketone type correspond more preferably to formula B:

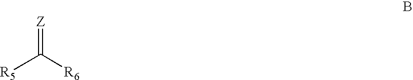

in which:

R₅ is different than R₆,

R₅ and R₆ represent a hydrocarbon-based radical containing from 1 to 30 carbon atoms optionally comprising one or more functional groups,

R₅ and R₆ can form a ring optionally comprising another hetero atom,

Z is or comprises an oxygen or nitrogen hetero atom or a functional group comprising at least one of these hetero atoms.

These compounds are specifically described in FR 96/08060 and EP 97930607.3.

A first preferred group of such keto substrates has the formula B1:

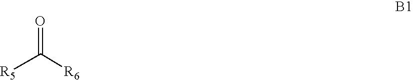

in which:

R₅ is different than R₆, the radicals R₅ and R₆ represent a hydrocarbon-based radical containing from 1 to 30 carbon atoms optionally comprising another ketone and/or acid, ester, thioacid or thioester function;

R₅ and R₆ can form a substituted or unsubstituted carbocyclic or heterocyclic ring containing 5 or 6 atoms.

Among these compounds, the ones that are most particularly preferred are the ketones chosen from:

methyl phenyl ketone,

isopropyl phenyl ketone,

cyclopropyl phenyl ketone,

allyl phenyl ketone,

p-methylphenyl methyl ketone,

benzyl phenyl ketone,

o-bromoacetophenone,

α-bromoacetone,

α-dibromoacetone,

α-chloroacetone,

α-dichloroacetone,

α-trichloroacetone,

1-chloro-3,3-dichloroacetone

1-fluoro-2-oxobutane,

1-chloro-3-methyl-2-butanone,

α-chloroacetophenone, α1-chloro-3-phenylacetone,

α-methylaminoacetone,

α-dimethylaminoacetone,

1-butylamino-2-oxopropane,

1-dibutylamino-2-oxopropane,

1-methylamino-2-oxobutane,

1-dimethylamino-2-oxobutane,

1-dimethylamino-3-methyl-2-oxobutane,

1-dimethylamino-2-oxopentane,

α-hydroxyacetone,

1-hydroxy-3-methyl-2-butanone,

1-hydroxy-2-oxobutane,

1-hydroxy-2-oxopentane,

1-hydroxy-2-oxohexane,

1-hydroxy-2-oxo-3-methylbutane,

α-hydroxyacetophenone,

1-hydroxy-3-phenylacetone,

α-methoxyacetone,

α-methoxyacetophenone,

α-butoxyacetophenone,

α-chloro-p-methoxyacetophenone,

α-naphthenone,

1-ethoxy-2-oxobutane,

1-butoxy-2-oxobutane.

Substrates of aldehyde/ketone type containing a second carbonyl group in an α, β, γ or δ position relative to the first carbonyl group are also particularly suitable in the context of the invention. Examples of such diketo compounds are:

3,4-dioxohexane,

4,5-dioxooctane,

1-phenyl-1,2-dioxopropane,

1-phenyl-2,3-dioxobutane,

1,2-cyclopentanedione,

1,2-cyclohexanedione,

acetylacetone,

3,5-heptanedione,

1-phenyl-1,3-butanedione,

1-phenyl-1,3-pentanedione,

1-phenyl-1,3-hexanedione,

1-phenyl-1,3-heptanedione,

1,3-bis(trifluoromethyl)-1,3-propanedione,

3-chloro-2,4-pentanedione,

1,5-dichloro-2,4-pentanedione,

1,5-dihydroxy-2,4-pentanedione,

1,5-dibenzyloxy-2,4-pentanedione,

1,5-diamino-2,4-pentanedione,

1,5-bis(methylamino)-2,4-pentanedione,

1,5-bis(dimethylamino)-2,4-pentanedione,

methyl 3,5-dioxohexanoate,

3-carbomethoxy-2,4-pentanedione,

3-carboethoxy-2,4-pentanedione,

1,3-cyclopentanedione,

1,3-cyclohexanedione,

1,3-cycloheptanedione.

As other substrates that are particularly suitable, mention may be made of keto acids or derivatives thereof and keto thioacids or derivatives thereof with a functional group (acid, ester, thioacid or thioester) in an α, β, γ or δ position relative to the carbonyl group. Examples of these are:

2-acetylbenzoic acid,

pyruvic acid,

2-oxobutanoic acid,

p-methoxyphenylpyruvic acid,

3,4-dimethoxyphenylpyruvic acid,

methyl acetoacetate,

ethyl acetoacetate,

n-propyl acetoacetate,

isopropyl acetoacetate,

n-butyl acetoacetate,

t-butyl acetoacetate,

n-pentyl acetoacetate,

n-hexyl acetoacetate,

n-heptyl acetoacetate,

n-octyl acetoacetate,

methyl 3-oxopentanoate,

methyl 4-fluoroacetoacetate,

ethyl 3-trifluoromethyl-3-oxopropanoate,

ethyl 4-hydroxy-3-oxobutanoate,

methyl 4-methoxyacetoacetate,

methyl 4-tert-butoxyacetoacetate,

methyl 4-benzyloxy-3-oxobutanoate,

ethyl 4-benzyloxy-3-oxobutanoate,

methyl 4-amino-3-oxobutanoate,

ethyl 3-methylamino-3-oxobutanoate,

methyl 4-dimethylamino-3-oxobutanoate,

ethyl 4-dimethylamino-3-oxobutanoate,

methyl 2-methylacetoacetate,

ethyl 2-methylacetoacetate,

ethyl 2-chloroacetoacetate,

diethyl 2-acetylsuccinate,

diethyl 2-acetylglutarate,

dimethyl acetylmalonate,

methylpyruvate,

ethyl 3-methyl-2-oxobutanoate,

ethyl phenylglyoxolate,

methyl phenylpyruvate,

ethyl phenylpyruvate.

It should be noted that when a γ-keto acid or derivative needs to be asymmetrically hydrogenated, the product obtained is generally a γ-butyrolactone derivative and, in the case of a δ-keto acid, it is a valerolactone derivative.

Other examples of ketones which may be mentioned, inter alia, are the following monocyclic or polycyclic, saturated or unsaturated cyclic keto compounds:

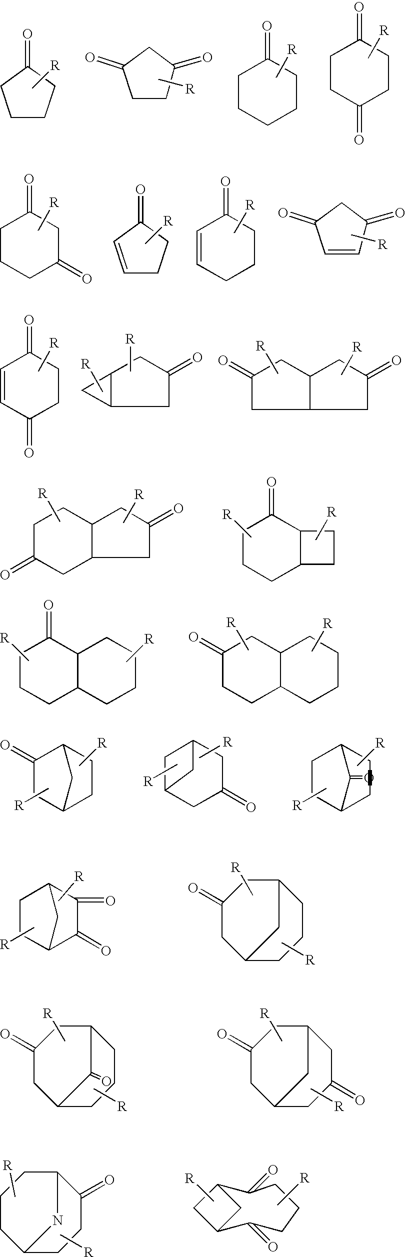

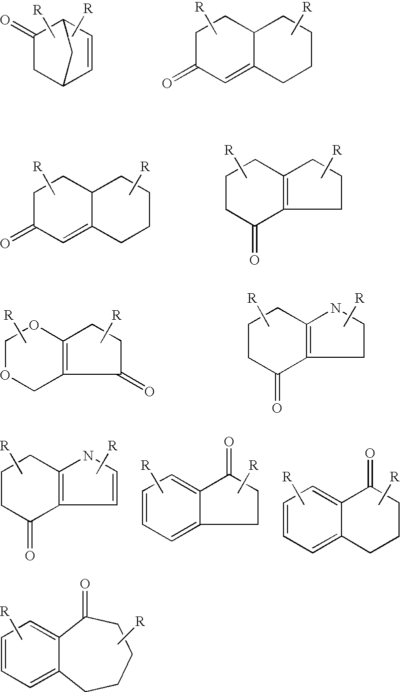

in which R represents a phenyl which is unsubstituted or substituted with alkyl or alkoxy radicals or a halogen atom; or R represents an alkyl or cycloalkyl group which is unsubstituted or substituted with alkyl or alkoxy radicals or a halogen atom, a hydroxyl, ether or amine group; or R represents a halogen atom or a hydroxyl, alkoxy or amine group.

Ketones of steroid type may also be used (for example 3-cholestanone or 5-cholesten-3-one).

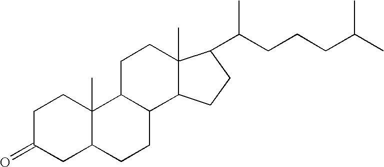

Other keto derivatives which may be mentioned are the compounds of formula B2:

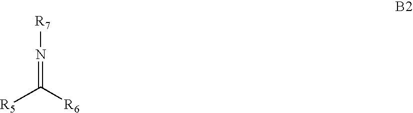

in which:

R₅, which is other than R₆, have the meaning given above,

R₇ represents:

a hydrogen atom,

a hydroxyl group,

a group OR₁₇,

a hydrocarbon radical R₁₇,

a group of formula

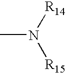

a group of formula

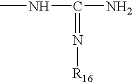

with R₁₄, R₁₅, R₁₆ and R₁₇ which represent a hydrogen atom or a hydrocarbon-based group containing from 1 to 30 carbon atoms.

Examples of compounds of formula B2 are:

N-alkylketoimines, such as:

N-isobutyl-2-iminopropane

N-isobutyl-1-methoxy-2-iminopropane

N-arylalkylketoimines, such as:

N-benzyl-1-imino-1-(phenyl)ethane

N-benzyl-1-imino-1-(4-methoxyphenyl)ethane

N-benzyl-1-imino-1-(2-methoxyphenyl)ethane

N-arylketoimines, such as:

N-phenyl-2-iminopentane

N-(2,6-dimethylphenyl)-2-iminopentane

N-(2,4,6-trimethylphenyl)-2-iminopentane

N-phenyl-1-imino-1-phenylethane

N-phenyl-1-methoxy-2-iminopropane

N-(2,6-dimethylphenyl)-1-methoxy-2-iminopropane

N-(2-methyl-6-ethylphenyl)-1-methoxy2-iminopropane

compounds of hydrazone type, optionally N-acylated or N-benzoylated:

1-cyclohexyl-1-(2-benzoylhydrazono)ethane,

1-phenyl-1-(2-benzoylhydrazono)ethane,

1-p-methoxyphenyl-1-(2-benzoylhydrazono)ethane,

1-p-ethoxyphenyl-1-(2-benzoylhydrazono)ethane,

1-p-nitrophenyl-1-(2-benzoylhydrazono)ethane,

1-p-bromophenyl-1-(2-benzoylhydrazono)ethane,

1-p-carboethoxyphenyl-1-(2-benzoylhydrazono)ethane,

1,2-diphenyl-1-(2-benzoylhydrazono)ethane,

3-methyl-2-(2-p-dimethylaminobenzoylhydrazono)butane,

1-phenyl-1-(2-p-methoxybenzoylhydrazono)ethane,

1-phenyl-1-(2-p-dimethylaminobenzoylhydrazono)ethane,

ethyl 2-(2-benzoylhydrazono)propionate,

methyl 2-(2-benzoylhydrazono)butyrate,

methyl 2-(2-benzoylhydrazono)valerate,

methyl 2-phenyl-2-(2-benzoylhydrazono)acetate.

Other starting substrates are semicarbazones and cyclic keto imines containing an endocyclic or exocyclic bond, such as:

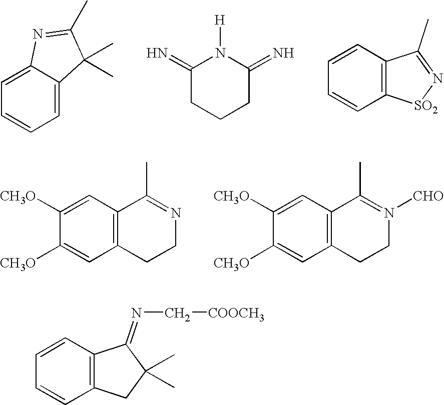

According to one particularly preferred embodiment of the invention, the substrate is a β-keto ester (such as ethyl acetoacetate or methyl 3-oxovalerate), an α-keto ester (such as methyl benzoylformate or methyl pyruvate), a ketone (such as acetophenone), or an α, β-ethylenic carboxylic acid (such as itaconic acid).

More particularly, the ruthenium complexes prepared from the ligands of the invention are suitable for the asymmetric catalysis of hydrogenation reactions of the C═O bonds of β-keto esters, α-keto esters or ketones.

The ruthenium complexes of the ligands of the invention are moreover suitable for the asymmetric catalysis of hydrogenation reactions of the C═C bonds of α, β-ethylenic carboxylic acids.

Thus, according to another of its aspects, the invention relates to the use of a water-soluble compound of the invention for the preparation of a metal complex of a transition metal for asymmetric catalysis, and more especially of a ruthenium, iridium or rhodium complex.

The invention moreover relates to the use of the combination of an optically active water-soluble compound according to the invention with a chiral or achiral diamine, for the selective reduction of ketones.

Advantageously, a chiral diamine is used in this combination.

The diamines that may be used for this purpose are the optically active diamines described in WO 97/20789 and the corresponding racemic diamines.

According to one particularly preferred embodiment of the invention, the diamine is 1,2-diamino-1,2-diphenylethane; 1,1-bis(p-methoxyphenyl)-2-(methyl-1,2-diaminoethane; 1,1-bis(p-methoxyphenyl)-2-isobutyl-1,2-diaminoethane; or 1,1-bis(p-methoxyphenyl)-2-isopropyl-1,2-diaminoethane.

Examples of chiral diamines are more particularly those of formula:

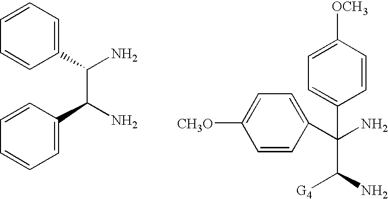

in which G₄ is alkyl, for example methyl, isobutyl or isopropyl.

Mention will be made more particularly of achiral ethylenediamine and chiral or achiral 1,2-diamino-1,2-diphenylethane, such as R,R-1,2-diamino-1,2-diphenylethane.

The ketones that may be reduced according to this process are those described above.

The conditions for carrying out the reduction are those generally described above.

The invention also relates to the use of the combination of a racemic water-soluble compound according to the invention with a chiral diamine, for the selective reduction of ketones.

The chiral diamine that may be used is as described in Wo 97/20789, the ketones and the operating conditions being as defined above.

The examples given below more specifically illustrate the invention.

Preparation 1

Preparation of (S)-6,6′-dibromo-2,2′-dihydroxy-1,1′-binaphthyl

7.7 g (26.9 mmol) of (S)-2,2′-dihydroxy-1,1′-binaphthyl are dissolved in 145 ml of dichloromethane. The solution is cooled to −75° C. and 3.66 ml of Br₂ (71.7 mmol) are then added dropwise over 30 minutes with constant stirring. The solution is stirred for a further 2 and a half hours and then cooled to room temperature. After addition of 180 ml of sodium bisulfite (10% by mass), the organic phase is washed with saturated NaCl solution and dried over Na₂SO₄. After evaporating off the solvent, the solid obtained is recrystallized from a toluene/cyclohexane mixture at 80° C. to give 9.8 g (22 mmol, 82% yield) of expected product.

The optical rotation as measured on a Perkin-Elmer-241 polarimeter (I=10 cm, 25° C., concentration c in g/dm³) is 124.3 at c=1.015 and 578 nm.

For the preparation of the dibromo derivative of the title, reference may be made to G. Dotsevi et al., J. Am. Chem. Soc., 1979, 101, 3035.

Preparation 2

Preparation of (S)-6,6′-dibromo-2,2′-bis(trifloromethanesulfonyloxy)-1,1′-binaphthyl

9.52 g (21.4 mmol) of (S)-6,6′-dibromo-2,2′-dihydroxy-1,1′-binaphthyl are dissolved in a mixture of 40 ml of CH₂Cl₂ and 5.4 ml of pyridine. After cooling the mixture to 0° C., 8.7 ml (14.5 g, 51.5 mmol) of triflic anhydride ((CF₃—SO₂)₂O) are added slowly. After stirring for 6 h, the solvent is evaporated off and the reaction mass is dissolved in 100 ml of ethyl acetate. After washing with aqueous 5% HCl solution, saturated NaHCO₃ solution and saturated NaCl solution, the organic phase is dried over Na₂SO₄ and the solvent is then evaporated off under reduced pressure. The yellow oil is purified by chromatography on silica (CH₂Cl₂) to give 12.5 g (17.7 mmol, 83% yield) of expected product.

[α]_{D}=151.3° (c=1.005, THF), the optical rotation being measured under the same conditions as in Preparation 1, but at the wavelength corresponding to the D line of sodium.

For the preparation of the title compound, reference may also be made to the studies by M. Vondenhof Tetrahedron Letters, 1990, 31, 985.

Preparation 3

Preparation of (S)-6,6′-dibromo-2,2′-bis(trifluoromethanesulfonyloxy)-1,1′-binaphthyl

As a variant, the title compound may be prepared from (R)-6,6′-dibromo-2,2′-dihydroxy-1,1′-binaphthyl according to the procedure described below.

10.0 g (22.52 mmol) of (R)-6,6′-dibromo-2,2′-dihydroxy-1,1′-binaphthyl are dissolved in a solution of 6.3 g (0.11 mol) of KOH in 300 ml of degassed water. The mixture is cooled to 0° C. and a solution of 11.4 ml (19.1 g, 68 mmol) of triflic anhydride in 200 ml of CCl₄ is then added over 45 minutes such that the temperature does not exceed 10° C. After stirring for 30 min, 300 ml of CH₂Cl₂ are added. The organic phase is washed with water and then dried over MgSO₄. 15.89 g of crude product are then purified by chromatography on silica (1/1 CH₂Cl₂/cyclohexane) to give 12.94 g (18.27 mmol, 81% yield) of pure product.

[α]_{D}=−153.2° (c=0.945, THF), the optical rotation being measured under the same conditions as in Preparation 1, but at the wavelength corresponding to the D line of sodium.

¹H NMR (CDCl₃, 200 MHz): δ (ppm): 7.07 (d(J_{H-H}=7.07), CH, 2H); 7.48 (dd(J¹_{H-H}=9.05; J²_{H-H}=1.94), CH, 2H); 7.62 (d(J_{H-H}=9.11), CH, 2H);p 8.06 (d(J_{H-H}=9.13), CH, 2H); 8.18 (d(J_{H-H}=1.90), CH, 2H).

¹³C NMR (CDCl₃, 200 MHz); δ (ppm) 118.1 (Cq(J_{C-F}=320)); 120.2 (Cq); 120.7 (CH); 122.0 (Cq); 123.4 (Cq); 128.2 (CH); 130.5 (CH); 131.4 (CH); 131.6 (Cq); 131.7 (CH); 133.4 (Cq).

Preparation 4

Preparation of (S)-6,6′-dicyano-2,2′-bis(trifluoromethanesulfonyloxy)-1,1′-binaphthyl

12.5 g (17.7 mmol) of the compound prepared in Preparation 2 and 3.5 g (38.8 mmol) of CuCN are stirred at 180° C. in 20 ml of N-methylpyrrolidone for 4 h. After cooling to room temperature, the black suspension is poured into a solution of 15 ml of diaminoethane in 35 ml of water. The solution is extracted several times with 30 ml of CH₂Cl₂ and the organic phase is washed with aqueous 10% KCN solution and saturated NaCl solution. After drying over Na₂SO₄, the solvent is evaporated off under reduced pressure. The black oil thus obtained is purified by chromatography on silica (9/1 CH₂Cl₂/cyclohexane) to give 6.5 g (10.8 mmol, 61% yield) of pure product.

[α]_{D}=−171.7° (c=1.15, THF), the optical rotation being measured under the same conditions as in Preparation 1, but at the wavelength corresponding to the D line of sodium.

¹H NMR (CDCl₃, 200 MHz); δ (ppm)=7.30 (d(J_{H-H}=9.81), CH, 2H); 7.59 (dd(J¹_{H-H}=8.82, J²_{H-H}=1.65), CH, 2H); 7.78 (d(J_{H-H}=9.11), CH, 2H); 8.29 (d(J_{H-H}=8.09), CH, 2H); 8.46 (d(J_{H-H}=1.29), CH, 2H).

¹³C NMR (CDCl₃, 200 MHz): δ (ppm)=111.7 (CN); 118.0 (Cq); 118.1 (Cq(J_{C-F}=320)); 121.6 (CH); 123.3 (Cq); 127.7 (CH); 128.9 (CH); 131.4 (Cq); 133.2 (CH); 134.4 (Cq); 134.5 (CH); 147.4 (Cq).

For the preparation of the title compound, those skilled in the art may refer to the studies by Friedman et al., J. Org. Chem. 1961, 26, 2522 and M. S. Neuman et al., J. Org. Chem., 1961, 26, 2525.

Preparation 5

Preparation of (S)-6,6′-dicyano-2,2′-bis(diphenyl phosphino)-1,1′-binaphthyl

A solution of NiCl₂dppe (371 mg, 0.7 mmol) and of diphenylphosphine (3 ml, 17 mmol) in 14 ml of DMF (anhydrous and degassed) is heated for 30 minutes at 100° C. in a 100 ml three-necked round-bottomed flask on which is mounted an argon inlet. (S)-6,6′-Dicyano-2,2′-bis(trifluoromethanesulfonyloxy)-1,1′-binaphthyl (4.4 g, 7.4 mmol) and DABCO (3.375 g, 30 mmol) dissolved in 20 ml of DMF are added dropwise. The reaction medium is left at 100° C. After 1.3 and 7 hours, 0.75 ml of diphenylphosphine is added. The solution is stirred for 2 days. It is then cooled to 0° C. and then filtered under argon and washed with methanol (2×10 ml). Finally, the solid is dried under vacuum to give the expected product in a yield of 50%.

Elemental analysis for C₄₆H₃₀N₂P₂

calculated: C=80.88; H=4.43; N=4.10; P=9.07;

found: C=81.61; H=4.45; N=4.11; P=8.99.

¹H NMR (CDCl₃, 200 MHz) δ (ppm): 6.59 (d, 2H, CH); 6.87 (dd, 2H, CH); 6.92-6.99 (m, 4H, CH); 7.09 (t, 4H, CH); 7.17-7.31 (m, 12H, CH); 7.57 (d, 2H, CH); 7.95 (d, 2H, CH); 8.20 (s, 2H, CH).

¹³C NMR (CDCl₃, 50 MHz) δ (ppm): 109.8 (CN); 119.0 (Cq); 126.3 (CH); 127.7 (CH); 128.4 (CH); 128.5 (CH); 128.5 (CH); 128.6 (CH); 128.8 (CH); 129.3 (CH); 132.0 (CH); 132.1 (Cq); 132.9 (CH(triplet J_{C-P}=11.7); 133.9 (Cq); 134.1 (Cq); 134.9 (CH(triplet J_{C-P}=9.9)); 136.8 (Cq); 140.6 (Cq).

³¹P NMR (CDCl₃, 81 MHz) δ (ppm): −12.75.

Preparation 6

Preparation of (S)-6,6′-bis(aminomethyl)-2,2′-bis(diphenylphosphino)-1,1′-binaphthyl (I: A=naphthyl; Ar₁=Ar₂=—C₆H₅)

557 mg (14.7 mmol) of LiAlH₄ are dissolved in a mixture of THF (30 ml)/toluene (60 ml) in a 250 ml round-bottomed flask placed under an argon atmosphere. (S)-6,6′-Dicyano-2,2′-bis(diphenylphosphino)-1,1′-binaphthyl (650 mg, 0.97 mmol) is added to this solution, which is stirred and refluxed for 4 hours. It is then cooled to 0° C. 600 μl of water and 600 μl of 15% NaOH are added. 2 g of Celite are then added and the mixture is filtered through a Millipore filter under argon. 60 ml of dichloromethane are added and the mixture is stirred and filtered again. This operation is carried out three times. The organic phase obtained is washed with saturated aqueous NaCl solution and then dried over Na₂SO₄. The solvent is evaporated to give a yellow solid (657 mg, quantitative yield) characterized by NMR (proton, carbon and phosphorus) corresponding to the expected structure.

Elemental analysis for C₄₆H₃₈N₂P₂

calculated: C=80.59; H=6.00; N=3.55; P=7.84;

found: C=81.14; H=5.51; N=3.13; P=7.90.

¹H NMR (CDCl₃, 200 MHz) δ (ppm): 1.68 (s, 4H, NH₂); 3.81 (s, 4H, CH₂); 6.72 (s, 4H, CH); 6.9-7.3 (m, 20H, CH); 7.33 (d, 2H, CH); 7.64 (s, 2H, CH); 7.76 (d, 2H, CH).

³¹P NMR (CDCl₃, 81 MHz) δ (ppm): −15.08.

Preparation 7

Preparation of (R)-6,6′-bis(aminomethyl)-2,2′-bis(diphenylphosphino)-1,1′-binaphthyl (I: A=naphthyl; Ar₁=Ar₂=—C₆H₅)

This compound is prepared by carrying out the sequence of reactions illustrated in preparations 1 to 6 above, but starting with (R)-2,2′-dihydroxy-1,1′-binaphthyl.

### EXAMPLE 1

Preparation of (S)-6,6′-bis(ammoniomethyl)-2,2′-bis(diphenylphosphino)-1,1′-binaphthyl dihydrobromide (dihydrobromide of compound I in which A=naphthyl; Ar₁=Ar₂=C₆H₅).

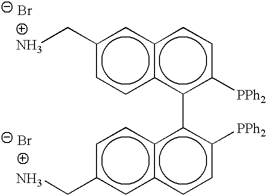

17 mg of (S)-6,6′-bis(aminomethyl)-2,2′-bis(diphenylphosphino)-1,1′-binaphthyl (0.025 mmol) are dissolved, under an argon atmosphere, in 1 ml of CH₂Cl₂.

8.4 μl of a solution of HBr (0.05 mmol) in water are added to this solution and the reaction mixture is stirred for 1 hour at room temperature. The solution is then evaporated and the product obtained is analyzed by infrared spectrometry.

IR (KBr pastille): 3500-2200 cm⁻¹ broad band characteristic of NH₃⁺; 2962 cm⁻¹ and 2924 cm⁻¹ aliphatic C—H; 1437 cm⁻¹, 1261 cm⁻¹ and 803 cm^{-1 3} fine bands characteristic of naphthyls.

### EXAMPLE 2

Preparation of the Ruthenium Complex of the Salt of Example 1.

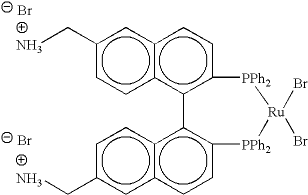

Under an argon atmosphere, 16 mg (0.024 mmol) of the compound of example 1 and 7.5 mg (0.024 mmol) of bis(2-methylallyl)cycloocta-1,5-diene ruthenium (II) complex are dissolved in 1 ml of acetone.

8.4 μl of a solution of HBr (0.05 mmol) in water are added to the above solution and the reaction mixture is stirred for 30 minutes at room temperature. The acetone is then evaporated off and the complex thus formed is used without further modification.

### EXAMPLE 3

Preparation of the Complex of Example 2, in a Single Step, Starting with (S)-6,6′-bis(aminomethyl)-2,2′-bis(diphenylphosphino)-1,1′-binaphthyl

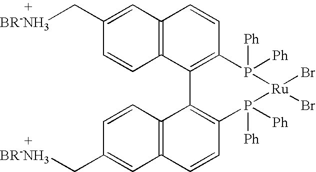

Under an argon atmosphere, 10 mg (0.0147 mmol) of (S)-6,6′-bis(aminomethyl)-2,2′-bis(diphenylphosphino)-1,1′-binaphthyl and 4.69 mg (0.0147 mmol, 1 eq.) of the bis(2-methylallyl)cycloocta-1,5-diene Ru (II) complex (30-32% Ru) are dissolved in a solution of hydrobromic acid in acetone (0.87 mol/L) (0.0588 mmol, 4 eq.). The reaction mixture is stirred for 30 minutes at room temperature and the acetone is then evaporated off. The complex thus formed is used without further modification.

### EXAMPLE 4

Preparation of a Polyoxyalkylene Derivative of Formula II in which R₁=R₂=H; R₃=—CH₃; W=O—CH₂—CO—; A=naphthyl; Ar₁=Ar₂=—C₆H₅; n=110-113

Under an argon atmosphere, 40 mg (0.059 mmol) of (S)-6,6′-bis(aminomethyl)-2,2′-bis(diphenylphosphino)-1,1′-binaphthyl or of (R)-6,6′-bis(aminomethyl)-2,2′-bis(diphenylphosphino)-1,1′-binaphthyl (respectively) are dissolved in 5 ml of dichloromethane, and 587 mg (0.118 mmol, 2 eq.) of O-[(N-succinimidyloxycarbonyl)methyl]-O′-methylpolyethylene glycol (Fluka) (molar mass≈5000 g/ml) are then added. After stirring for 24 hours at room temperature, 500 mg (0.55 mmol) of aminomethylpolystyrene are added. The reaction mixture thus obtained is stirred for 2 hours and then filtered and washed with 6 mL of dichloromethane. After evaporating the filtrate, 460 mg of the title compound are obtained, i.e. a 73% yield.

The term (S)-HydroNAP denotes the polymer obtained from (S)-6,6′-bis(aminomethyl)-2,2′-bis(diphenylphosphino)-1,1′-binaphthyl, and (R)-HydroNAP denotes the polymer obtained from (R)-6,6′-bis(aminomethyl)-2,2′-bis(diphenylphosphino)-1,1′-binaphthyl.

By way of example, the spectral data for characterization of (S)-HydroNAP are given below.

[α]_{D}=−12.75° (c=0.8; H₂O) at 19° C.

IR (KBr pastille); 3450, 2890, 1710, 1610, 1470, 1360, 1340, 1280, 1150, 1110, 1060, 960, 842.

¹H NMR (500 MHz): δ (ppm): 2.90 (broad s, CH₃O); 3.00 (broad s, CH₂O); 3.10 (broad s, CH₂O); 3.1-3.4 (m, CH₂O); 3.40 (broad s, CH₂O); 3.5-3.8 (m, CH₂O); 4.0-4.1 (m, CH₂O); 4.45 (broad s, CH₂N); 6.5-7.8 (m, aromatic H),

³¹P NMR (81 MHz) δ (ppm): −15.02.

These spectral data characterize a 1:2 mixture of the dipolyoxyalkylene compound of formula II defined in the title and of the corresponding monopolyoxyyalkylene compound, as demonstrated by time-of-flight mass spectrometry.

MALDI-TOF-MS (Matrix Assisted Laser Desorption/Ionisation Time of Flight/Mass Spectrometery): 6009.5 (monopolyoxyalkylene); 11557.9 (dipolyoxyalkylene of formula II)

### EXAMPLE 5

Preparation of a Ruthenium Complex of the Polyoxyalkylene Derivative of Example 4

Under an argon atmosphere, a solution of 100 mg (9.36×10⁻³ mmol) of the polymer (S)-HydroNAP of example 4 and 2.2 mg (8.9×10-3 mmol) of [RuCl₂(benzene)]₂ (ACROS) in 1 ml of dimethylformamide is stirred at 100° C. for 15 minutes. After cooling to 50° C., the solvent is evaporated off under reduced pressure. After cooling to room temperature, the evaporation is continued under reduced pressure (0.1 mbar) to lead to the formation of an orange solid.

### EXAMPLE 6

Hydrogenation of Ethyl Acetoacetate

The general hydrogenation protocol is as follows:

Pre-degassed water (v1) is added, under argon, to the conical reactor in which the catalyst has just been prepared. The water-insoluble ethyl acetoacetate (v2, x2 mmol) is then added (catalyst/substrate ratio: 1/1000). The operation consisting in placing the reactor under vacuum and filling it is repeated three times. The septum is then replaced with a pierced stopper and the reactor is then placed in an autoclave. The autoclave is purged three times under argon and then three times under hydrogen before receiving a pressure of 40 bar of hydrogen. The autoclave is placed on a magnetic stirrer-hotplate at a temperature of 50° C. and stirring is maintained overnight. After cooling, the stopper is replaced with a septum and argon is then reinjected into this reactor: the reaction mixture is denoted solution M hereinbelow.

An aliquot of solution M (single phase) is injected into a chromatography column for gas chromatography (Lipodex A 25 m×0.25 mm). Solution M is extracted twice with 10 ml of pentane. For the recycling, the aqueous phase containing the catalyst is reacted with v2 (x2 mmol) of ethyl acetoacetate.

In all cases, the hydrogenation of ethyl acetoacetate gives ethyl 3-hydroxybutanoate.

The exact operating conditions and the results obtained are given in the following table:

| | | | | Degree of | Enantiomeric |
|---|---|---|---|---|---|
| Catalyst | v1 | v2 | ×2 | conversion | excess |
| complex | (ml) | (ml) | (mmol) | (%) | (%) |
| Example 2 | 1 | 2.15 | 23.5 | 100 | 94 |
| freshly | | | | | |
| prepared | | | | | |
| Example 3 | 1 | 1.86 | 14.7 | 50 | 70 |
| freshly | | | | | |
| prepared | | | | | |
| Example 5 | 0.5 | 1.1 | 8.9 | 100 | 75 |
| freshly | | | | | |
| prepared | | | | | |
| Example 2 | 1 | 2.15 | 23.5 | 97 | 91 |
| after a 1st | | | | | |
| recycling | | | | | |
| Example 2 | 1 | 2.15 | 23.5 | 100 | 94 |
| after a 2nd | | | | | |
| recycling | | | | | |
| Example 2 | 1 | 2.15 | 23.5 | 100 | 83 |
| after a 3rd | | | | | |
| recycling | | | | | |
| Example 3 | 1 | 1.86 | 14.7 | 7 | 78 |
| after a 1st | | | | | |
| recycling | | | | | |
| Example 5 | 0.5 | 1.1 | 8.9 | 20 | 56 |
| after a 1st | | | | | |
| recycling | | | | | |

### EXAMPLE 7

Hydrogenation of Itaconic Acid

Pre-degassed water (0.5 ml) is added, under argon, to the conical reactor in which the catalyst complex of example 5 has just been prepared. Itaconic acid (24.4 mg, 0.187 mmol) is then added (catalyst/substrate ratio: 1/1000). The operation consisting in placing the reactor under vacuum and filling it with argon is repeated three times. The septum is then replaced with a pierced stopper and the reactor is then placed in an autoclave. The autoclave is purged three times under argon and then three times under hydrogen before receiving a pressure of 40 bar of hydrogen. The autoclave is placed on a magnetic stirrer at a temperature of 10° C. and stirring is maintained overnight. The reactor is then recovered, the stopper being replaced with a septum, and argon is reinjected into this reactor. The solution is placed in a 50 ml round-bottomed flask, the water is evaporated off under vacuum and the solid obtained is dissolved in 20 ml of methanol. 3 ml of thionyl chloride are added to this mixture to esterify the acid at room temperature. After reaction for 2 hours, the solution is evaporated and the resulting solid is then dissolved in 20 ml of methanol. The solution thus obtained is ready to be injected into a chromatography column for gas chromatography to analyze the activity and enantioselectivity of the reaction.

The hydrogenation of itaconic acid leads to 2-methylbutane-1,4-dioic acid. The determination of the enantiomeric excesses is performed by chiral chromatography on the corresponding ester on a β-DEX 2×30 m×0.25 mm column. The results obtained are:

a degree of conversion of 91%

an enantiomeric excess of 19%

### EXAMPLE 8

Hydrogenation of Methyl Benzoylformate

Pre-degassed water (0.5 ml) is added, under argon, to the conical reactor in which the catalyst has just been prepared. Water-insoluble methyl benzoylformate (0.63 ml, 4.46 mmol) is then added (catalyst/substrate ratio: 1/1000). The operation consisting in placing the reactor under vacuum and filling it with argon is repeated three times. The septum is then replaced with a pierced stopper and the reactor is then placed in an autoclave. The autoclave is purged three times under argon and then three times under hydrogen, before receiving a pressure of 40 bar of hydrogen. The autoclave is placed on a magnetic stirrer-hotplate at a temperature of 50° C. and stirring is maintained overnight. The reactor is then recovered, the stopper being replaced with a septum, and argon is reinjected into this reactor. The organic phase diluted in 10 ml of methanol is injected into a chromatography column for gas chromatography (Lipodex A 25 m×0.25 mm).

The hydrogenation of methyl benzoylformate leads to methyl 1-hydroxy-1-phenylethanoate.

The following are obtained:

a degree of conversion of 60%;

an enantiomeric excess of 13%.

### EXAMPLE 9

Preparation of a Ruthenium Complex of the Polyoxyalkylene Derivative of Example 4

Under an argon atmosphere, a solution of 50 mg (0.046 mmol) of the polymer (R)-HydroNAP of example 4 and 1.15 mg (0.024 mmol) of [RuCl₂(benzene)]₂ in 1 ml of pre-degassed dimethylformamide is stirred at 100° C. for 10 minutes. After cooling to 25° C., 1 mg (0.046 mmol) of (R,R)-diphenylethylenediamine is added and the solution is stirred for 3 hours. The solvent is then evaporated off under reduced pressure (0.1 mbar) to lead to the formation of an orange complex.

### EXAMPLE 10

Hydrogenation of Acetophenone in Two-Phase Medium

Pre-degassed water (1 ml) and 10 mg (0.25 mmol) of NaOH are added, under argon, to the conical reactor in which the catalyst of example 9 has just been prepared. Water-insoluble acetophenone (2.69 ml, 23 mmol) is then added (catalyst/substrate ratio: 1/5000). The operation consisting in placing the reactor under vacuum and filling it with argon is repeated three times. The septum is then replaced with a pierced stopper and the reactor is then placed in an autoclave. The autoclave is purged three times under argon and then three times under hydrogen, before receiving a pressure of 40 bar of hydrogen. The autoclave is placed on a magnetic stirrer-hotplate at a temperature of 50° C. and stirring is maintained overnight. The reactor is then recovered, the stopper being replaced with a septum, and argon is reinjected into this reactor. The organic phase diluted in 15 ml of methanol is injected into a chromatography column for gas chromatography (Lipodex A 25 m×0.25 mm).

The hydrogenation of acetophenone leads to 1-phenyl-1-ethanol.

The following are obtained:

a degree of conversion of 100%;

an enantiomeric excess of 21%.

### EXAMPLE 11

Hydrogenation of Acetophenone in One-Phase Medium

Pre-degassed methanol (0.5 ml) is added, under argon, to the conical reactor in which the catalyst has just been prepared. Acetophenone (0.52 ml, 4.46 mmol), potassium hydroxide and the diamine (1 eq.) are then added (catalyst/substrate ratio: 1/1000). The operation consisting in placing the reactor under vacuum and filling it with argon is repeated three times. The septum is then replaced with a pierced stopper and the reactor is then placed in an autoclave. The autoclave is purged three times under argon and then three times under hydrogen, before receiving a pressure of 40 bar of hydrogen. The autoclave is placed on a magnetic stirrer-hotplate at a temperature of 50° C. and stirring is maintained overnight. The reactor is then recovered, the stopper being replaced with a septum, and argon is reinjected into this reactor. The organic phase diluted in 10 ml of methanol is injected in GC (Lipodex A 25 m×0.25 mm).

The hydrogenation of acetophenone leads to 1-phenyl-1-ethanol, with a conversion of 100% and an enantiomeric excess of 26%.

1. A water-soluble compound of formula α 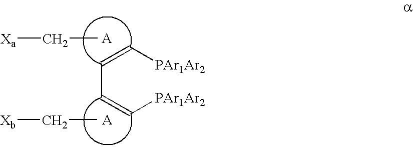
in which:
A represents naphthyl or phenyl; and
Ar₁ and Ar₂ independently represent an aromatic or saturated carbocyclic group;
Xₐ and X_{b} are independently chosen from an amino group, an ammonium group and an amino group modified with a linear polyoxyalkylene chain;
it being understood that at least one from among Xₐ and X_{b} represents ammonium or modified amino.

2. The compound as claimed in claim 1 of formula α, which is an ammonium salt in which at least one from among Xₐ and X_{b} represents an ammonium group.

3. The compound as claimed in claim 2, which is the addition product of a compound of formula I 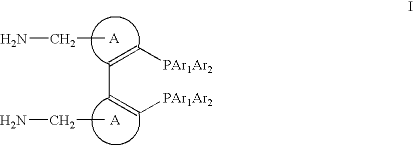
in which A, Ar₁ and Ar₂ are as defined in claim 1, with a mineral or organic acid.

4. The compound as claimed in claim 3, characterized in that the mineral acid is chosen from a hydrohalic acid, a sulfuric acid, nitric acid and a phosphoric acid.

5. The compound as claimed in claim 3, characterized in that the organic acid is chosen from a carboxylic acid, a polycarboxylic acid and a sulfonic acid.

6. The compound as claimed in claim 1, of formula α, which is a polyoxyalkylene derivative (i) in which at least one from among Xₐ and X_{b} represents amino modified with a linear polyoxyalkylene chain.

7. The compound as claimed in claim 6, characterized in that said polyoxyalkylene derivative (i) is a linear polyoxyalkylene bearing at least one group G₁: 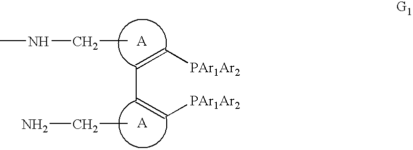
in which A, Ar₁ and Ar₂ are as defined in claim 1.

8. The compound as claimed in claim 6, characterized in that said polyoxyalkylene derivative (i) consists of at least one group G₂: 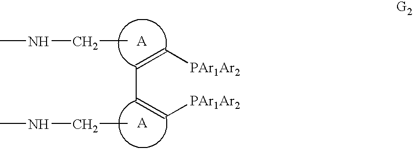
in which A, Ar₁ and Ar₂ are as defined in claim 1, each amino radical of said group G₂ being attached to a polyoxyalkylene chain.

9. The compound as claimed in either of claims 7 and 8, characterized in that the NH radicals of the groups G₁ or G₂ are linked to the end of a polyoxyalkylene chain via a bridging chain of formula:
—C-alk-Din
which C is linked to —NH— and D is linked to the oxygen atom of the end of the polyoxyalkylene chain, and in which
C represents a bond, the group —CO—; or —CO—NH—;
alk represents a bond, an alkylene group or a group —CH(L)- in which L is the side chain of an α-amino acid to which a polyoxyalkylene chain is optionally grafted; and
D represents a —CO— group; —NH—CO—; or a —CH(OH)—CH₂— group.

10. The compound as claimed in claim 9, characterized in that said bridging chain of formula —C-alk-D- is chosen from:
-alk-NH—CO—;
—CO-alk-CO—;
-alk-CO—;
-alk-CH(OH)—CH₂—; and
—CO
in which alk represents alkylene;
or alternatively said residue represents:
—CO—NH—CH(L)-CO
in which L is the side chain of an α-amino acid onto which is optionally grafted a polyoxyalkylene chain.

11. The compound as claimed in claim 10, characterized in that said bridging chain of formula —C-alk-D is chosen from —CH₂—CH₂—NH—CO—; —CO—CH₂—CH₂—CO—; —CH₂—CH₂—CO—; —CO—; —CH₂—CO—; —CH₂—CH(OH)—CH₂; —CO—NH—CH(L)-CO— in which L represents the side chain of an α-amino acid, or alternatively the side chain of a basic α-amino acid containing a terminal amino group substituted with —CO—O—POA, POA representing a polyoxyalkylene chain.

12. The compound as claimed in claim 11, characterized in that L represents the side chain of glycine (H) in which the side chain of norleucine [-(—CH₂)₃—OH] or the group —(CH₂)₄—NH—CO—O—POA.

13. The compound as claimed in claim 7 or 8, characterized in that the groups G₁ or G₂ do not cap the ends of the polyoxyalkylene chain to which they are attached, the —NH— radicals of said groups G₁ and/or G₂ being linked to said polyoxyalkylene chain via a bridging chain of formula -alk-CO— in which alk represents alkylene, preferably —CH₂—CH₂—, —CO— being linked to —NH— and alk being directly attached to the polyoxyalkylene chain.

14. The compound as claimed in any one of claims 7 to 13, characterized in that said polyoxyalkylene derivative comprises a single group G₁ or a single group G₂.

15. The compound as claimed in claim 7, characterized in that said polyoxyalkylene derivative is a linear polyoxyalkylene bearing from 2 to 20 and preferably from 4 to 10 groups G₁, which do not cap the ends of the polyoxyalkylene chain.

16. The compound as claimed in any one of claims 1 to 15, characterized in that the repeating unit of said polyoxyalkylene chain has the general formula: 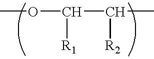
in which
R₁ and R₂ are independently chosen from a hydrogen atom;
an alkyl group optionally substituted with aryl; alkoxy and/or aryloxy; an aryl group; each aryl group optionally being substituted.

17. The compound as claimed in claim 16, characterized in that R₁ and R₂ represent a hydrogen atom.

18. The compound as claimed in any one of the preceding claims, characterized in that the ends of said polyoxyalkylene chain not bearing a group G₁ or G₂ are capped with a hydroxyl or alkoxy group.

19. The water-soluble compound as claimed in claim 8, of formula II 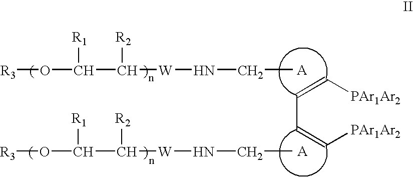
in which
A, Ar₁ and Ar₂ are as defined in claim 1,
R₁ and R₂ are as defined in claim 16 or 17,
n ranges between 5 and 150, preferably between 15 and 150 and better still between 50 and 120;
R₃ represents H or alkyl;
W represents —O—C-alk-D, in which C, alk and D are as defined in any one of claims 9 to 11, it being understood that POA preferably represents the group: 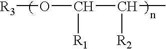
in which R₁, R₂, n and R₃ are as defined above.

20. The compound as claimed in claim 19, characterized in that R₁ and R₂ represent a hydrogen atom.

21. The compound as claimed in any one of the preceding claims, characterized in that:
A represents naphthyl or phenyl, optionally substituted with one or more radicals chosen from (C₁-C₆)alkyl and (C₁-C₆) alkoxy; and
Ar₁ and Ar₂ independently represent a phenyl group optionally substituted with one or more (C₁-C₆)alkyl or (C₁-C₆)alkoxy; or a (C₄-C₈)cycloalkyl group optionally substituted with one or more (C₁-C₆)alkyl groups.

22. The compound as claimed in any one of the preceding claims, characterized in that Ar₁ and Ar₂ are independently chosen from phenyl optionally substituted with methyl or tert-butyl; and (C₅-C₆)cycloalkyl optionally substituted with methyl or tert-butyl.

23. The compound as claimed in any one of the preceding claims, characterized in that Ar₁ and Ar₂ are identical and preferably represent optionally substituted phenyl.

24. The compound as claimed in any one of the preceding claims, characterized in that A represents naphthyl.

25. The compound as claimed in claim 24, of formula:

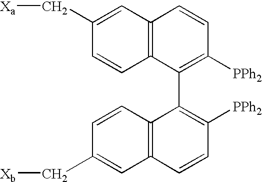

26. A complex of a transition metal comprising one or more compounds of formula a as defined in any one of claims 1 to 25, as a ligand.

27. The complex as claimed in claim 26, in which the transition metal is ruthenium, rhodium or iridium.

28. The use of one or more compounds as claimed in any one of claims 1 to 25, as a ligand for preparing a metal complex of a transition metal that is useful in asymmetric catalysis.

29. The use as claimed in claim 28, characterized in that said complex is intended for catalyzing the asymmetric hydrogenation of C═O bonds or of C═C bonds.

30. The use as claimed in either of claims 27 and 28, characterized in that the metal complex is a complex of ruthenium, rhodium or iridium.

31. The use of a combination of an optically active water-soluble compound as claimed in any one of claims 1 to 25 with a chiral or achiral diamine, for the selective reduction of ketones.

32. The use of a combination of a racemic water-soluble compound as claimed in any one of claims 1 to 25, with a chiral diamine, for the selective reduction of ketones.

33. The use as claimed in claim 31 or 32, characterized in that the diamine is chiral or achiral 1,2-diamino-1,2-diphenylethane.

34. The use of a combination of a racemic water-soluble compound as claimed in any one of claims 1 to 25, with a water-soluble additive of polyoxyalkylene type, for the selective reduction of ketones.
